(19) United States
(12) Patent Application Publication
(10) Pub. No.: US 2024/0400322 A1
(43) Pub. Date: Dec. 5, 2024

(54) RESILIENTLY IMPACTABLE CONTROL MASTS AND RELATED METHODS

(71) Applicant: Rite-Hite Holding Corporation, Milwaukee, WI (US)

(72) Inventors: Jason T. Dondlinger, Bellevue, IA (US); Tony W. Duesing, Bellevue, IA (US); Nicholas John Casey, Cascade, IA (US); Aaron J. Wiegel, Benton, WI (US); Greg D. Proffitt, Waukesha, WI (US); Seth Edward Kampa, Saukville, WI (US); Matthew J. Sveum, Wauwatosa, WI (US); Nicholas A. Beyer, New Berlin, WI (US)

(21) Appl. No.: 18/731,012

(22) Filed: May 31, 2024

Related U.S. Application Data
(60) Provisional application No. 63/505,317, filed on May 31, 2023.
(60) Provisional application No. 63/597,436, filed on Nov. 9, 2023.

(51) Int. Cl. B65G 69/28

(52) U.S. Cl. CPC B65G 69/287

(57) ABSTRACT

Resiliently impactable control masts and related methods are disclosed. An example control panel includes a post to support a control box for the control panel. The example control panel also includes a deflection system including: an anchor to support the post, the anchor couplable to a platform; a shaft to extend upward from the anchor along a length of the post; and a shock absorbing body adjacent the shaft, the shock absorbing body to absorb at least some of an impact with the control panel.

### CROSS-REFERENCE TO RELATED APPLICATION

This patent claims the benefit of both U.S. Provisional Patent Application No. 63/505,317, filed May 31, 2023, and U.S. Provisional Patent Application No. 63/597,436, filed Nov. 9, 2023. U.S. Provisional Patent Application No. 63/505,317, and U.S. Provisional Patent Application No. 63/597,436 are incorporated by reference herein in their entireties. Priority to U.S. Provisional Patent Application No. 63/505,317, and U.S. Provisional Patent Application No. 63/597,436 is hereby claimed.

### FIELD OF THE DISCLOSURE

This disclosure relates generally to control masts and, more particularly, to resiliently impactable control masts and related methods.

### BACKGROUND

Material handling facilities often include loading docks to receive and/or ship out cargo. Some loading docks are constructed for the unloading and/or loading of trucks. Other loading docks are constructed for the unloading and/or loading of railcars. Regardless of whether trucks, trains, or any other mode of transport is involved, such docks often include a control panel to control operation of equipment (e.g., dock levelers, railcar ramp systems, etc.) that facilitate the loading and/or unloading of cargo loading bay, a warehouse, an interior of a warehouse, an exterior of a warehouse, etc.

### BRIEF DESCRIPTION OF THE DRAWINGS

FIG. 1 is a perspective view of an example loading bay implemented with an example railcar ramp system in accordance with teachings disclosed herein.

FIG. 2 is a side view of the example loading bay of FIG. 1 showing an example railcar parked at the example loading bay and the example railcar ramp system in an example first operational or endload position.

FIG. 3 is a side view of the example loading bay of FIG. 1 showing the example railcar parked at the example loading bay and the example railcar ramp system in an example second operational or deployed position.

FIG. 4 is a perspective view of the example railcar ramp system of FIGS. 1-3.

FIG. 5 is a perspective view of the example railcar ramp system of FIGS. 1-4.

FIG. 6A is an enlarged, front view of an example control panel of the example railcar ramp system of FIGS. 1-5.

FIG. 6B is another enlarged, front view of the example control panel of FIG. 6A.

FIG. 6C is an enlarged, rear view of the example control panel of FIG. 5.

FIG. 7 is a cross-sectional view of the example control panel.

FIG. 8A is a side view of the example control panel shown in an example deflected position.

FIG. 8B is a partial, enlarged view of FIG. 8A.

FIG. 9A is an enlarged perspective, rear view of the example control panel of FIG. 8A in the example deflected position.

FIG. 9B is an enlarged perspective, front view of the example control panel of FIG. 8A in the deflected position.

FIGS. 10A-10E are different views of the example control panel disclosed herein coupled to fixed platform of an example loading dock.

FIG. 11A is a perspective view of another example loading dock including another example control panel disclosed herein.

FIG. 11B is another perspective view of the example control panel of FIG. 11A.

FIG. 12 is a perspective, rear view of the example control panel of FIGS. 11A and 11B.

FIG. 13 is a front view of the example control panel of FIGS. 11A, 11B and 12 in an example first position.

FIG. 14 is a front view of the example control panel of FIGS. 11A, 11B and 12 in an example second position.

FIG. 15A is a perspective view of another example control panel disclosed herein.

FIG. 15B is another perspective view of the example control panel of FIG. 15A.

FIG. 15C is a perspective, rear view of the example control panel of FIGS. 15A and 15B.

FIG. 15D is a side view of the example control panel of FIGS. 15A and 15B.

FIG. 16A is a front perspective view of another example railcar ramp system similar to FIG. 11, but showing a rear perspective view of a different example control panel.

FIG. 16B is a front perspective view of the example control panel of FIG. 16A with the surrounding structure of the railcar ramp system removed for the sake of clarity.

FIG. 16C is a rear view of the example control panel of FIG. 16B.

FIG. 16D is a top view of the example control panel of FIG. 16B.

FIG. 16E is a bottom view of the example control panel of FIG. 16B.

FIG. 17 illustrates an exploded view of the example control panel of FIGS. 16A and 16B that includes an enlarged, exploded view of the internal components of an example first deflection system.

FIG. 18A is a cross-sectional side view of the example control panel of FIG. 16A taken along a plane passing vertically through the example first deflection system.

FIG. 18B illustrates an enlarged view of the first deflection system shown in FIG. 18A.

FIG. 19A illustrates a cross-sectional side view of the example control panel similar to what is shown FIG. 18A but showing the control panel during an impact.

FIG. 19B illustrates an enlarged view of the first deflection system shown in FIG. 19A.

FIG. 20 is a cross-sectional top view of the example first deflection system taken along line 20-20 of FIG. 18A.

FIG. 21 is a perspective view of the example control panel of FIGS. 17-20 at the edge of a pit at an example loading dock.

FIG. 22A is a rear perspective view of the example control panel of FIG. 21 that has been modified in accordance with teaching disclosed herein.

FIG. 22B is a front perspective view of the example control panel of FIG. 22A with the surrounding structure removed for the sake of clarity.

In general, the same reference numbers will be used throughout the drawing(s) and accompanying written description to refer to the same or like parts. The figures are not necessarily to scale. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

### DETAILED DESCRIPTION

Railyards and/or warehouses employ cargo terminals or loading docks for loading and/or unloading goods between the loading docks and railcars. The loading dock typically includes a platform, and the railcar is positioned substantially parallel relative to the platform to enable loading/unloading of cargo or goods between a cargo area or bed of the railcar and the platform via a side door of the railcar oriented toward the platform. To span a gap between and/or to compensate for height difference between a platform of a loading lock and a cargo bed of a railcar (e.g., a boxcar), the loading dock typically employs a railcar ramp (e.g., a hydraulic railway ramp). In addition, it can be difficult to properly align a railcar with the railcar ramp. Thus, in addition to compensating for height difference between the platform and the cargo bed, railcar ramps are often slidably coupled to the platform to enable lateral adjustment and/or alignment of the railcar ramp relative to a side door of a railcar. After the railcar ramp is positioned relative to the side door of the railcar, a loading/unloading operation can be achieved by a material handling vehicle, such as a conventional forklift truck, that can access the cargo through the side door of the railcar.

To move the railcar ramp laterally along a longitudinal axis of the railcar, the railcar ramp often employs a motorized or hydraulic mover system. Specifically, the motorized system often includes a motor coupled to a transmission system that moves the railcar ramp along a track. Such motorized transmission systems can include a rack-and-pinon, a gear transmission, a chain, and sprocket transmission, and/or any other transmission that can be operated by a motor. A hydraulic system can include a hydraulic cylinder connected to the carriage and a fixed mount bolted directly to the dock face. Such motorized systems are often expensive and prone to wear, which increases maintenance costs and/or increases downtime of a cargo terminal or loading dock.

Additionally, methods, apparatus, and articles of manufacture disclosed herein employ an impactable control panel. Specifically, railcar ramps often employ motorized and/or hydraulic systems to move the railcar ramp (e.g., vertically) relative to the cargo area of the railcar. Such a control panel is often positioned adjacent relative to the railcar ramp. As such, control panels of railcar ramp systems are susceptible to damage when impacted by material handling equipment during a loading/unloading operation. Similar control panels can also be used in other settings such as at loading docks for loading and/or unloading of trucks and/or at other locations associated with material handling facilities. Example control panels can also be used in these settings and locations.

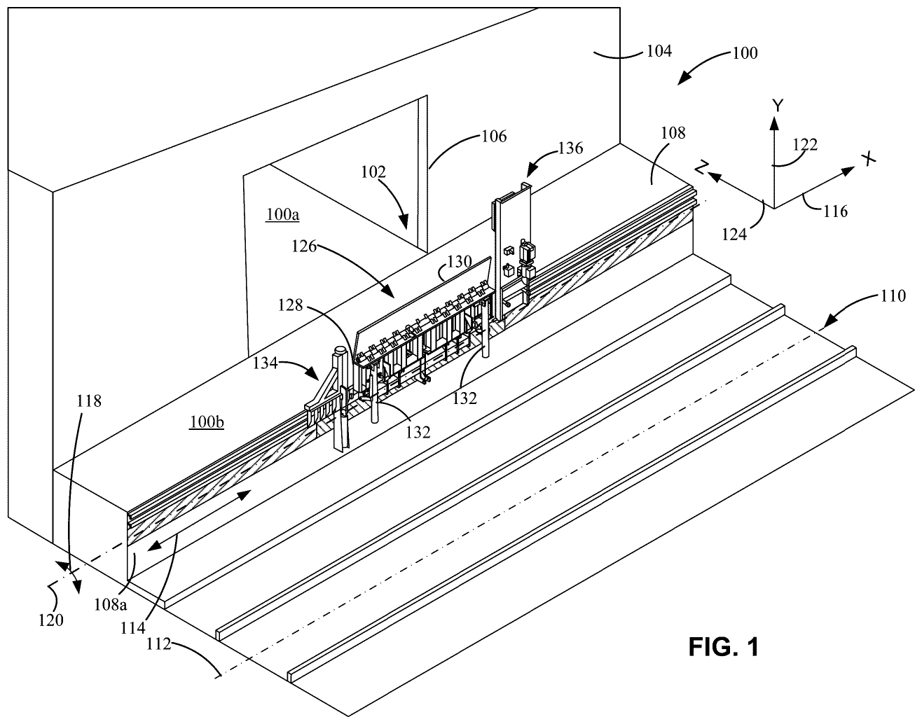

FIG. 1 is a perspective view of an example loading bay 100 implemented with an example railcar ramp system 102 in accordance with teachings disclosed herein. The loading bay 100 of the illustrated example can be a warehouse, a railyard, cargo transport unit, and/or loading structure. The loading bay 100 of the illustrated example includes a building wall 104 defining a doorway 106 leading to a platform 108 (e.g., the doorway 106 allows access between an interior 100a of the loading bay 100 and an exterior 100b of the loading bay 100). The loading bay 100 of the illustrated example includes a rail 110 for receiving one or more railcars (e.g., boxcars) of a freight train. The rail 110 defines a longitudinal axis 112. In the illustrated example, the rail 110 and/or the longitudinal axis 112 extends substantially parallel relative to the building wall 104.

The railcar ramp system 102 of the illustrated example is coupled to a platform face or front face 108a (e.g., a dock face, a front face, a vertical wall, a platform face, etc.) of the platform 108. The railcar ramp system 102 of the illustrated example enables alignment of the railcar ramp system 102 and a railcar when a railcar is not in alignment (e.g., perfect alignment) with the doorway 106 and/or the railcar ramp system 102. For example, the railcar ramp system 102 of the illustrated example is to span a gap and/or compensate for height difference between the platform 108 of the loading bay 100 and a cargo bed of a railcar (e.g., a boxcar). In addition to compensating for a height difference between the platform 108 and the cargo bed, the railcar ramp system 102 moves (e.g., slides) in a first direction 114 (e.g., a bi-directional lateral or horizontal direction, first and second lateral directions) relative to the platform 108 to enable lateral adjustment and/or alignment of the railcar ramp system 102 relative to a railcar (e.g., relative to a side door of a railcar). In the illustrated example, the first direction 114 is bi-directional along the longitudinal axis 112. As used herein, the first direction 114 of the railcar ramp system 102 is in a direction substantially parallel or perfectly parallel along the longitudinal axis 112 (e.g., an x-axis 116 in the illustrated example of FIG. 1). As such, to laterally align a railcar door and the railcar ramp system 102 and/or to span the gap (e.g., a vertical gap) between a railcar cargo area and the platform 108 of the loading bay 100, the railcar ramp system 102 is movable in the first direction 114 (e.g., a lateral or horizontal direction) and a second direction 118 (e.g., a vertical or rotational direction) about a pivot axis 120. Thus, the first direction 114 is different than the second direction 118. In some examples, the railcar ramp apparatus moves in the first direction 114 along a plane defined by the x-axis 116 and a y-axis 122 in the orientation of FIG. 1, and the second direction 118 along a plane defined by the y-axis 122 and a z-axis 124 in the orientation of FIG. 1.

To span a gap between a rail car and the platform 108, the railcar ramp system 102 of the illustrated example includes a ramp or leveler 126 (e.g., a ramp assembly or system). The leveler 126 of the illustrated example includes a deck 128, a lip 130 and end loading legs 132. To laterally align the railcar ramp system 102 relative to the platform 108, the railcar ramp system 102 of the illustrated example includes a ramp mover 134. The ramp mover 134 of the illustrated example is configurable to selectively move the ramp assembly in the first direction 114 (e.g., laterally) along the platform 108. Additionally, to support one or more electronic components (e.g., motors, controllers, hydraulic reservoirs, etc.) of the railcar ramp system 102, the railcar ramp system 102 of the illustrated example includes a control panel 136.

While one loading bay 100 is illustrated in FIG. 1, the loading bay 100 can include a plurality of loading bays positioned adjacent to the loading bay 100. In some such examples, each of the loading bays can include a dedicated railcar ramp system. Alternatively, two or more bays can share a single railcar ramp system.

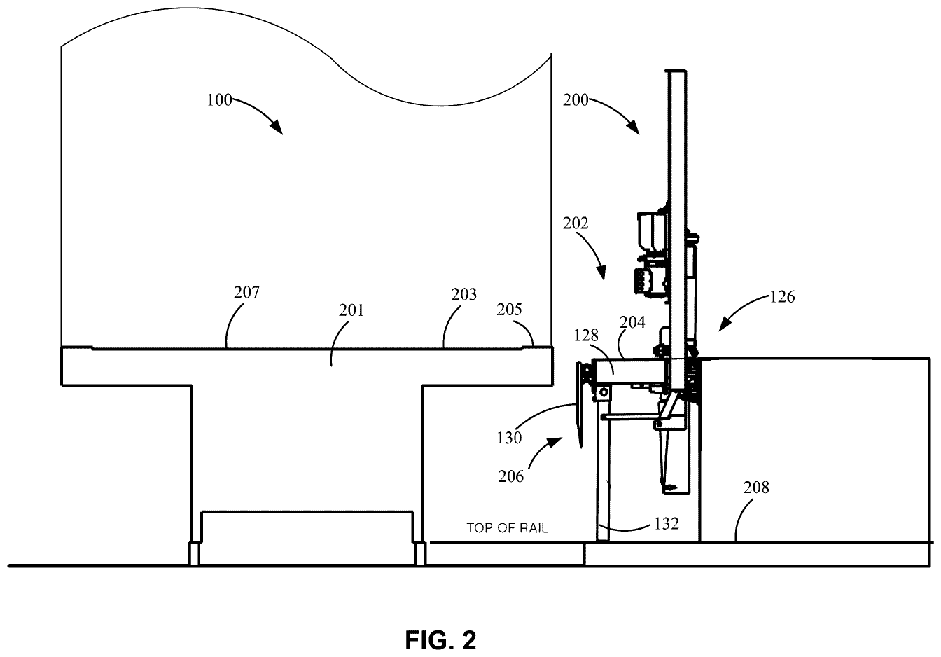

FIG. 2 is a side view of the example loading bay 100 of FIG. 1 showing an example railcar 201 parked at the loading bay 100 and the railcar ramp system 102 in a first operational position 200. When the railcar 201 is parked at the loading bay 100 adjacent the doorway 106 (FIG. 1), a height differential (e.g., a gap or vertical gap in the orientation of FIG. 2)) can exist between the platform 108 and a cargo area 203 of the railcar 201 (e.g., a boxcar, etc.). Additionally, a lateral misalignment can exist between the railcar 201 or railcar doorway 205 (e.g., a side doorway) oriented toward the doorway 106 of the loading bay 100 and/or the railcar ramp system 102 in a direction along the longitudinal axis 112 (FIG. 1). To reduce or eliminate a lateral misalignment between the railcar doorway 205 and the railcar ramp system 102, the ramp mover 134 can be employed to move the railcar ramp system 102 laterally in the first direction 114 (FIG. 1) to reduce or eliminate the lateral gap. After the lateral gap is eliminated and/or the railcar doorway 205 is aligned laterally with the railcar ramp system 102, the railcar ramp system 102 can be deployed to span a gap (e.g., a vertical gap in the y-axis direction) between the platform 108 and the cargo area 203 of the railcar 201. For example, the railcar ramp system 102 can be positioned in the first operational position 200.

The first operational position 200 of the illustrated example is an end loading position 202. In the end loading position 202 of the illustrated example, the deck 128 of the leveler 126 is moved (e.g., pivoted) toward the railcar 201 in the second direction 118 (FIG. 1) such that an upper surface 204 of the deck 128 aligns with (e.g., is substantially parallel to) an upper surface 207 of the cargo area 203 of the railcar 201. The lip 130 of the leveler 126 is in a stowed position 206 (e.g., a retracted position). The end loading legs 132 are positioned to engage a lower surface 208 of the platform 108 to support the deck 128.

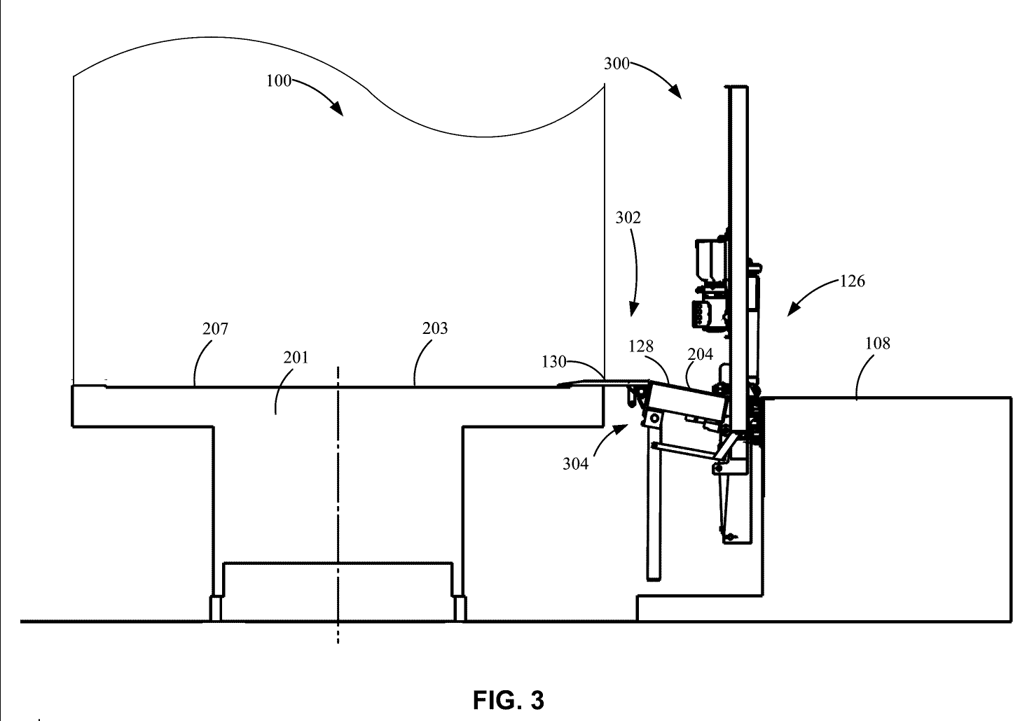

FIG. 3 is a side view of the loading bay 100 of FIG. 1 showing the example railcar 201 parked at the loading bay 100 and the railcar ramp system 102 in a second operational position 300. After the lateral gap is eliminated and/or the railcar doorway 205 is aligned laterally with the railcar ramp system 102, the railcar ramp system 102 can be deployed to span a gap (e.g., a vertical gap in the y-axis direction and/or a horizontal gap in the z-axis direction) between the platform 108 and the cargo area 203 of the railcar 201. For example, the railcar ramp system 102 can be positioned in the second operational position 300. The second operational position 300 of the illustrated example is an example standard loading position 302. In the standard loading position 302 of the illustrated example, the deck 128 is moved toward the railcar 201 in the second direction 118 (FIG. 1) where the upper surface 204 of the deck 128 is non-parallel relative to the upper surface 207 of the railcar 201. Additionally, the lip 130 is in an example extended position 304 and positioned at least partially on the upper surface 207 of the cargo area 203 to provide a continuous pathway (e.g., to be traversed by a vehicle) between the cargo area 203 and the platform 108.

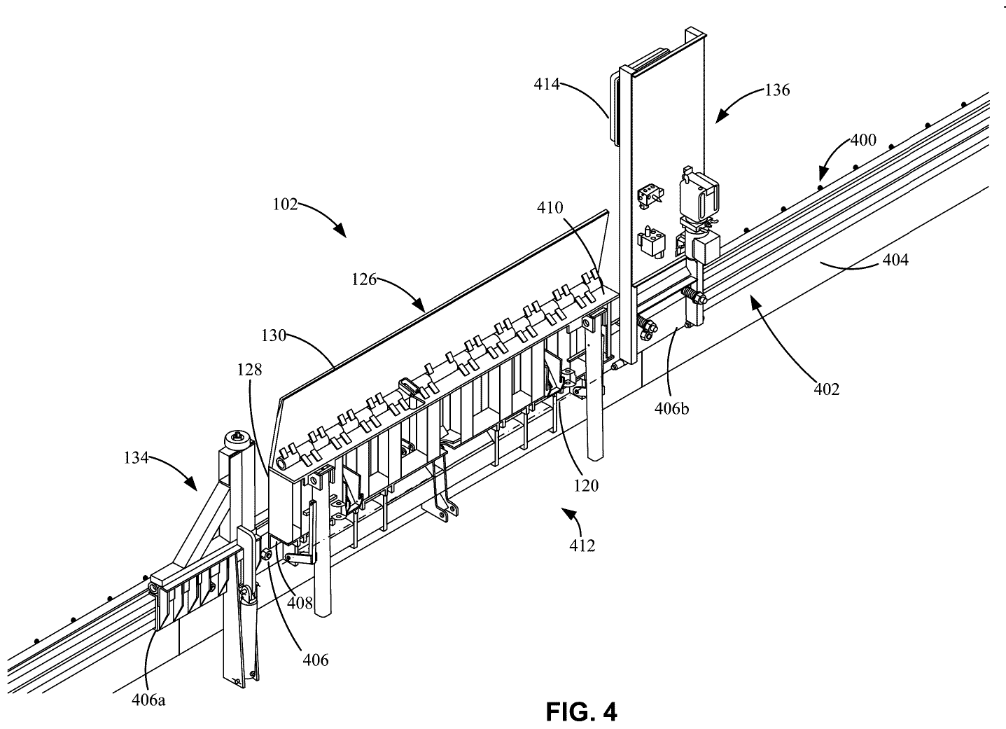

FIG. 4 is a perspective view of the railcar ramp system 102 of FIGS. 1-3. The railcar ramp system 102 includes the leveler 126, the ramp mover 134 and the control panel 136. To slidably couple the railcar ramp system 102 to the platform 108, the loading bay 100 and/or the railcar ramp system 102 of the illustrated example employs a track system 400. The track system 400 of the illustrated example includes guide rails 402 mounted to a plate 404. In some examples, the guide rails 402 can be from just a few feet longer than a railcar ramp in width and up to hundreds of feet long and/or any desired length and/or width (e.g., 35 feet long, 150 feet long, etc.). The plate 404 of the illustrated example couples to the front face 108a (FIG. 1) of the platform 108. When coupled to the platform 108, the guide rails 402 of the illustrated example are substantially parallel relative to the rails 110, the longitudinal axis 112 and/or the building wall 104 (FIG. 1).

To enable the railcar ramp system 102 to move relative to the platform 108 along the guide rails 402, the track system 400 and/or the railcar ramp system 102 of the illustrated example includes a carriage 406. The carriage 406 of the illustrated example is an elongated body having a first end 406a and a second end 406b opposite the first end 406a. Specifically, the leveler 126, the ramp mover 134 and the control panel 136 are coupled (e.g., mounted) to the carriage 406. In the illustrated example, the ramp mover 134 is coupled adjacent the first end 406a of the carriage 406, the control panel 136 is coupled adjacent the second end 406b of the carriage 406, and the leveler 126 is coupled between the first end 406a and the second end 406b of the carriage 406 (e.g., between the ramp mover 134 and the control panel 136). However, in other examples, the control panel 136 can be positioned between the leveler 126 and the ramp mover 134, the ramp mover 134 can be positioned between the leveler 126 and the control panel 136, and/or the control panel 136 can be positioned adjacent the first end 406a of the carriage 406 and the ramp mover 134 can be positioned adjacent the second end 406b of the carriage 406. As the carriage 406 moves along the guide rails 402, the railcar ramp system 102 (e.g., the leveler 126, the ramp mover 134 and the control panel 136) moves along the guide rails 402 (e.g., in the first direction 114).

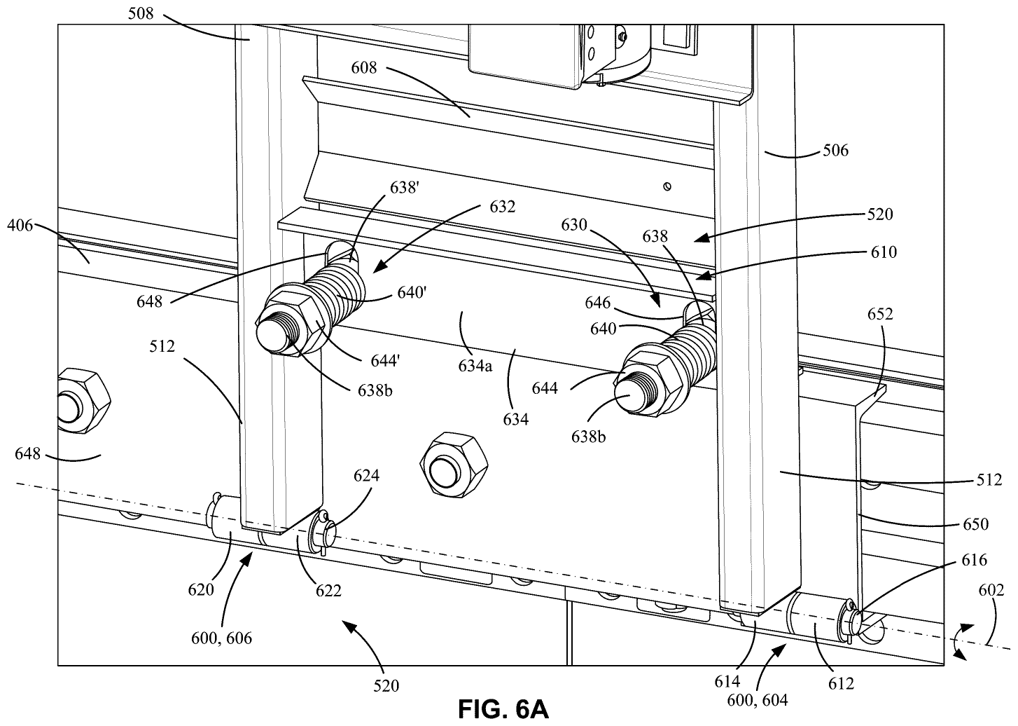

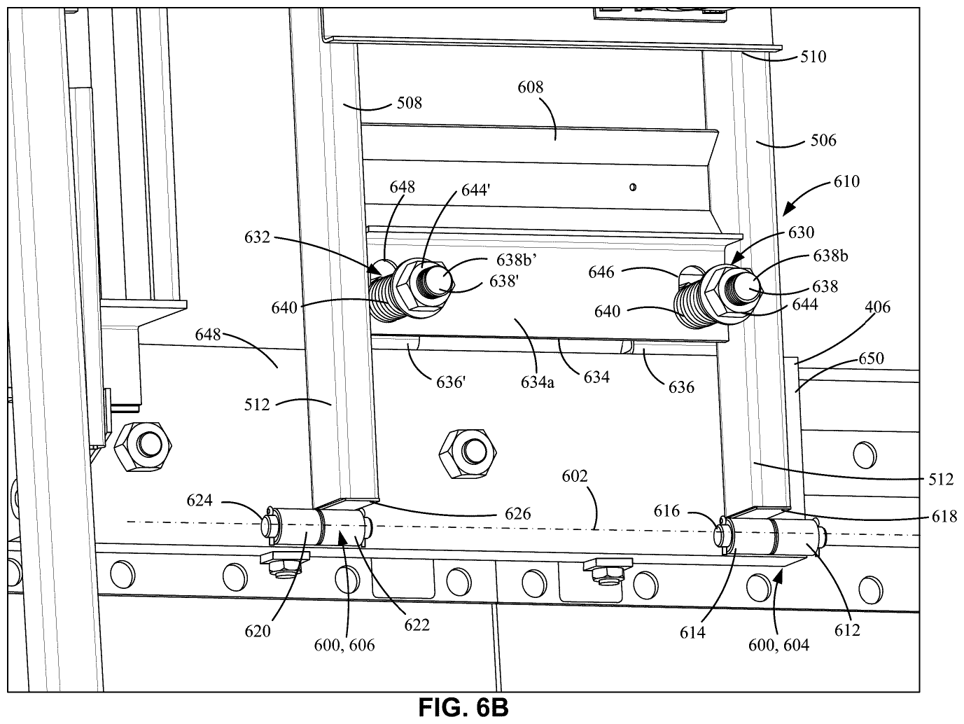

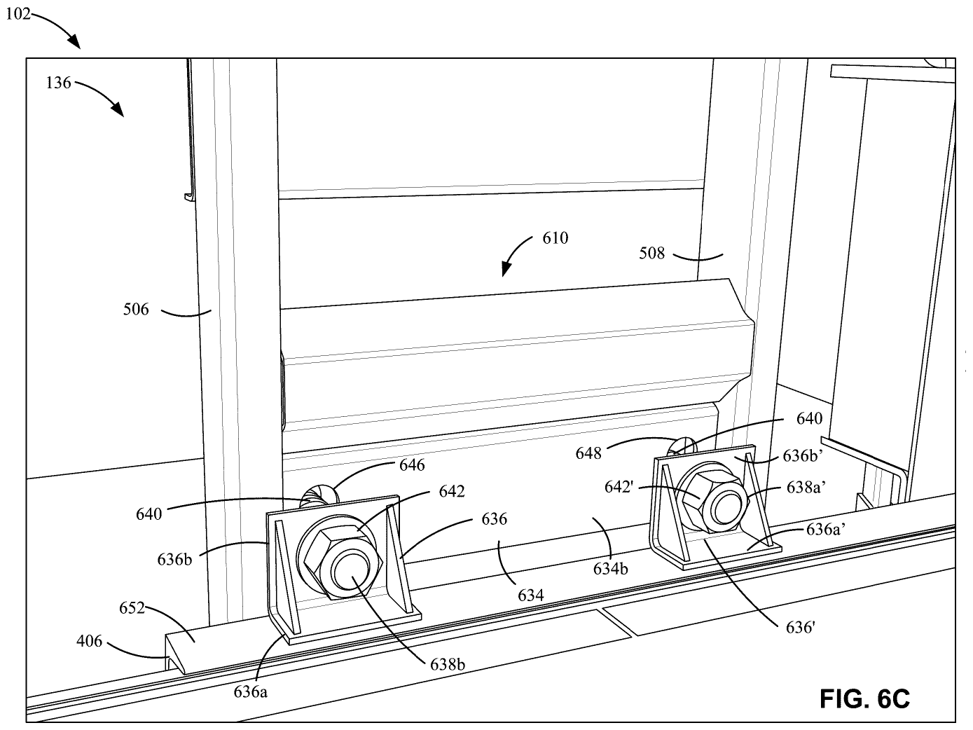

The deck 128 of the leveler 126 of the illustrated example is pivotally coupled (e.g., pivotally hinged) along a back edge 408 (e.g., a header) of the deck 128 to the carriage 406. To vary the height of a front edge 410 of the deck 128 of the leveler 126 relative to the cargo area 203 of the railcar 201, a drive system operates leveler 126. Specifically, the drive system causes the deck 128 to pivot or rotate about the pivot axis 120 between a stored position 412 shown in FIG. 4 and the first operating position 200 of FIG. 2 or the second operating position 300 of FIG. 3. The lip 130 of the illustrated example is pivotally coupled to the front edge 410 of the deck 128. To span a gap between the front edge 410 of the deck 128 and the cargo area 203, the drive system causes the lip 130 to move between the stowed position 206 of FIG. 6 to the extended position 304 of FIG. 3 such that the lip 130 extends outward from the front edge 410 of the deck 128 to engage the upper surface 207 of the cargo area 203. For example, movement of the leveler (e.g., the deck 128 and/or the lip 130) can be controlled electro-hydraulically from a push-button station supported by the control panel 136. Pushing a button on a control box 414 can operate the leveler 126 between the stored position 412 and the first operating position 200 and/or the second operating position 300 (i.e., to lower and/or raise the leveler 126). In some examples, the lip 130 can be extended or retracted at any time during a cycle from the push-button station. A hydraulic railcar ramp system can be powered by an electrohydraulic power unit with submerged hydraulic pump and direct connect reservoir. The system can be controlled by one or more solenoid valves (e.g., four solenoid valves). Although not shown, one or more electrical wires, fluid lines (e.g., hydraulic oil lines, pneumatic air lines, etc.) can be routed within the carriage 406 (e.g., a lower surface of the guide) between the leveler 126, the ramp mover 134 and/or the control panel 136 such that one or more electrical wires, fluid lines, etc. do not impede or hinder operation of the railcar ramp system 102 (e.g., as the railcar ramp system 102 moves between the stored position 412, the first operational position 200, the second operational position 300, and/or moves along the first direction 114 of FIG. 1). Example implementations of aspects of the railcar ramp system 102 of FIGS. 1-4 is provided in U.S. patent application Ser. No. 18/431,358, which is incorporated herein by reference in its entirety.

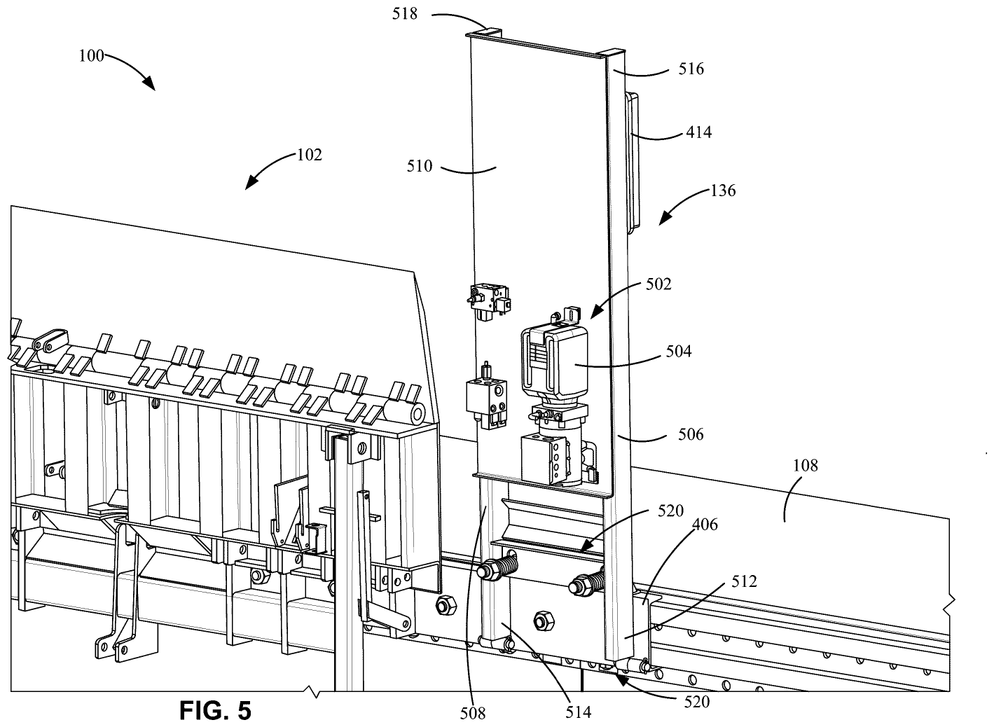

FIG. 5 is a perspective view of the railcar ramp system 102 of FIGS. 1-4. The control panel 136 of the illustrated example supports electronic components 502 including the control box 414, a power unit and valving system 504 and/or other electronic components for operating the leveler 126 and/or the ramp mover 134. The control panel 136 of the illustrated example includes a first post 506 (e.g., a beam, a mast, etc.), a second post 508 (e.g., a beam, a mast, etc.), and a panel 510 (e.g., a plate, sheet metal, a board, etc.). The panel 510 is coupled to the first post 506 and the second post 508 to span a distance therebetween. The control panel 136 of the illustrated example is coupled to the carriage 406. Specifically, the control panel 136 is coupled to the carriage 406 at respective first ends 512, 514 of the first post 506 and the second post 508. Respective second ends 516, 518 of the first post 506 and the second post 508 project upward or vertically from the carriage 406. The respective second ends 516, 518 are free moving ends (e.g., not fixed or attached to structure) and can move or pivot relative to the carriage 406 and/or the first ends 512, 514, respectively. The control panel 136 of the illustrated example includes a deflection system 520 to configure the control panel 136 as an impactable mast, post, beam, or other structure. As used herein, “impactable mast” means that the control panel 136 can flex, deflect, or pivot relative to the carriage 406 and/or platform 108 when subject to impacts (e.g., inadvertent impacts) by a vehicle (e.g., a forklift). In other words, the control panel 136 does not rip off or break from the carriage 406 and/or the platform 108 if impacted by a vehicle.

FIG. 6A is an enlarged, front view of the control panel 136 of FIG. 5. FIG. 6B is another enlarged, front view of the control panel 136. FIG. 6C is an enlarged, rear view of the control panel 136 of FIG. 5.

Referring to FIGS. 6A-6C, the deflection system 520 of the control panel 136 of the illustrated example includes a pivot hinge 600 and a biasing assembly 610. For example, the control panel 136 of the illustrated example is pivotally coupled to the carriage 406 via the pivot hinge 600 that enables the control panel 136 to pivot relative to the carriage 406 and/or the platform 108 about a pivot axis 602 defined by the pivot hinge 600. The pivot hinge 600 of the illustrated example includes a first pivot hinge 604 and a second pivot hinge 606. The first pivot hinge 604 pivotally couples the first post 506 and the carriage 406 and the second pivot hinge 606 pivotally couples the second post 508 and the carriage 406. Although the pivot hinge 600 of the illustrated example includes a first pivot hinge 604 and a second pivot hinge 606, the first pivot hinge 604 and the second pivot hinge 606 enable the first post 506 and the second post 508 to move or pivot simultaneously relative to the carriage 406 about the pivot axis 602 because the first post 506 is coupled to the second post 508 via the panel 510, an impact guard 608 and/or a biasing assembly 610.

The first pivot hinge 604 of the illustrated example includes a first knuckle 612, a second knuckle 614 and a first pin 616. The first knuckle 612 of the first pivot hinge 604 is coupled to the carriage 406. Specifically, the first knuckle 612 is attached to a front surface 648 of a face plate 652 of the carriage 406. For example, the first knuckle 612 is attached or fixed to the carriage 406 via, for example, welding. The second knuckle 614 is coupled to the first post 506. In this example, the second knuckle 164 is attached or fixed (e.g., welded) to an end surface 618 of the first end 512 of the first post 506. The first pin 616 maintains alignment of the first knuckle 612 and the second knuckle 614 relative to the pivot axis 602 to enable the first post 506 to pivot relative to the carriage 406 about the pivot axis 602.

The second pivot hinge 606 is substantially similar or identical to the first pivot hinge 604 (e.g., a mirror or the first pivot hinge 604). For example, the second pivot hinge 606 includes a third knuckle 620, a fourth knuckle 622, and a second pin 624. The third knuckle 620 of the second pivot hinge 606 is coupled to the carriage 406. Specifically, the third knuckle 620 is attached to the front surface 648 of the face plate 650 of the carriage 406. For example, the third knuckle 620 is attached or fixed to the carriage 406 via, for example, welding. The fourth knuckle 622 is coupled to the second post 508. In this example, the fourth knuckle 622 is attached or fixed (e.g., welded) to an end surface 626 of the first end 514 of the second post 508. The second pin 624 maintains alignment of the third knuckle 620 and the fourth knuckle 622 relative to the pivot axis 602 to enable the second post 508 to pivot relative to the carriage 406 about the pivot axis 602.

The biasing assembly 610 of the illustrated example maintains the control panel 136 in an upright orientation. For example, the biasing assembly 610 of the illustrated example biases the control panel 136 about the pivot axis 602 in a direction toward the carriage 406. In this manner, the first ends 512 of the respective first post 506 and the second post 508 are biased into engagement (e.g., direct contact) with the carriage 406 (e.g., the outer surface or front surface 648 of the carriage 406). Thus, when the control panel 136 is deflected or pivoted about the pivot axis 602 in a direction away from the carriage 406 and/or the platform 108, the biasing assembly 610 causes the control panel 136 to return to the upright orientation after an impact event.

The biasing assembly 610 of the illustrated example includes a first spring assembly 630, a second spring assembly 632, and a support plate 634 (e.g., a push plate). Although the biasing assembly 610 of the illustrated example is shown with a first spring assembly 630 and a second spring assembly 632, in some examples, the biasing assembly 610 can include only a single spring assembly or three or more spring assemblies.

The first spring assembly 630 of the illustrated example includes a first mounting bracket 636, a first fastener or screw 638 (e.g., a bolt), a first spring 640, a first fastener 642 (e.g., a nut) and a second fastener 644 (e.g., a nut). The first spring 640 of the illustrated example is a coil spring. However, in some examples, the first spring 640 can be a Belleville springs (e.g., stacked springs), torsion springs, leaf springs, a combination thereof, and/or any other suitable biasing element to bias the control panel to an upright orientation. The first screw 638 of the illustrated example is a bolt. The first screw 638 includes threads between a first end 638a of the first screw 638 and a second end 638b of the first screw 638 opposite the first end 638a. In some examples, the first screw 638 has a shank portion (e.g., a non-threaded portion) between the first end 638a and the second end 638b. The first end 638a is threaded to receive the first fastener 642 and the second end 638b is threaded to receive the second fastener 644. Each of the first fastener 642 and the second fastener 644 of the illustrated example is a nut and a washer. However, in some examples, the first fastener 642 and/or the second fastener 644 can be a clamp, a lock nut, a plate welded to the first screw 638, and/or any other fastener(s). In some examples, the first screw 638 can be a rod (e.g., a non-threaded rod) and the first fastener 242 and/or the second fastener 244 can be an end cap attached to the respective ends of the rod (e.g., via welding).

The first mounting bracket 636 of the first spring assembly 630 is mounted to the carriage 406. Specifically, the first mounting bracket 636 is mounted on or to a first (e.g., upper) flange 652 (e.g., leg) of the carriage 406. The first mounting bracket 636 includes a first bracket leg 636a and a second bracket leg 636b. The first bracket leg 636a is orthogonal relative to the second bracket leg 636b. Specifically, the first bracket leg 636a is oriented in a horizontal orientation or parallel relative to the first flange 652 of the carriage 406 and the second bracket leg 636b is oriented in a vertical orientation and/or perpendicular relative to the first flange 652 of the carriage 406. The first spring assembly 630 is cantilevered from the first mounting bracket 636. For example, the first end 638a of the first screw 638 is fastened or coupled to the first mounting bracket 636 via the first fastener 642 and the second end 638b of the first screw 638 extends through a first slot 646 (e.g., an oblong opening) formed in the support plate 634. The first spring 640 is supported by the first screw 638. In other words, the first screw 638 passes through an open opening of the first spring 640. The second fastener 644 couples to the second end 638b of the first screw 638 to retain the first spring 640 coupled to the first screw 638. In particular, the first spring 640 is captured between a first side 634a of the support plate 634 and the second fastener 644. The first side 634a of the support plate 634 is oriented away from the platform 108 and toward the rail 110 (FIG. 1). Thus, the first spring 640 is not positioned on a second side 634b of the support plate 634 that is oriented toward the first mounting bracket 636. Thus, the support plate 634 is positioned between the first spring 640 and the first mounting bracket 636.

The second spring assembly 632 of the illustrated example includes a second mounting bracket 636′, a second fastener or screw 638′ (e.g., bolt), a second spring 640′, a third fastener 642′ (e.g., a nut) and a fourth fastener 644′ (e.g., a nut). The second spring 640′ of the illustrated example is a coil spring. However, in some examples, the second spring 640′ can be a Belleville springs (e.g., stacked springs), torsion springs, leaf springs, a combination thereof, and/or any other suitable biasing element to bias the control panel to an upright orientation. The second screw 638′ of the illustrated example is a bolt. The second screw 638′ includes threads between a first end 638a′ of the second screw 638′ and a second end 638b′ of the second screw 638′ opposite the first end 638a′. In some examples, the second screw 638′ has a shank portion (e.g., a non-threaded portion) between the first end 638a′ and the second end 638b′. The first end 638a′ is threaded to receive the third fastener 642′ and the second end 638b′ is threaded to receive the fourth fastener 644′. Each of the third fastener 642′ and the fourth fastener 644′ of the illustrated example is a nut and a washer. However, in some examples, the third fastener 642′ and/or the fourth fastener 644′ can be a clamp, a lock nut, a plate welded to the second screw 638′, and/or any other fastener(s). In some examples, the second screw 638′ can be a rod (e.g., a non-threaded rod) and the third fastener 242′ and/or the fourth fastener 244′ can be an end cap attached to the respective ends of the rod (e.g., via welding).

The second mounting bracket 636′ of the second spring assembly 632 is mounted to the carriage 406. Specifically, the second mounting bracket 636′ is mounted on or to the first flange 652 of the carriage 406. The second mounting bracket 636′ includes a first bracket leg 636a′ and a second bracket leg 636b′. The first bracket leg 636a′ is orthogonal relative to the second bracket leg 636b′. Specifically, the first bracket leg 636a′ is oriented in a horizontal orientation or parallel relative to the first flange 652 of the carriage 406 and the second bracket leg 636b′ is oriented in a vertical orientation and/or perpendicular relative to the first flange 652 of the carriage 406. The second spring assembly 630′ is cantilevered from the second mounting bracket 636′. For example, the first end 638a′ of the second screw 638′ is fastened or coupled to the second mounting bracket 636′ via the third fastener 642′ and the second end 638b′ of the second screw 638′ extends through a second slot 648 formed in the support plate 634. The second spring 640′ is supported by the second screw 638′. In other words, the second screw 638′ passes through an open opening of the second spring 640′. The fourth fastener 644′ couples to the second end 638b′ of the second screw 638′ to retain the second spring 640′ coupled to the second screw 638′. In particular, the second spring 640′ is captured between the first side 634a of the support plate 634 and the fourth fastener 644′. The second spring 640′ is not positioned on the second side 634b of the support plate 634. Thus, the support plate 634 is positioned between the second spring 640′ and the second mounting bracket 636′. Because the deflection assembly 520 (e.g., the pivot hinge 600 and the biasing assembly 610) are supported by or coupled to the carriage 406, the deflection system 520 does not impede or obstruct movement of the carriage 406 in the first direction 114 when the carriage 406 is moved along the guide rails 402 via the ramp mover 134.

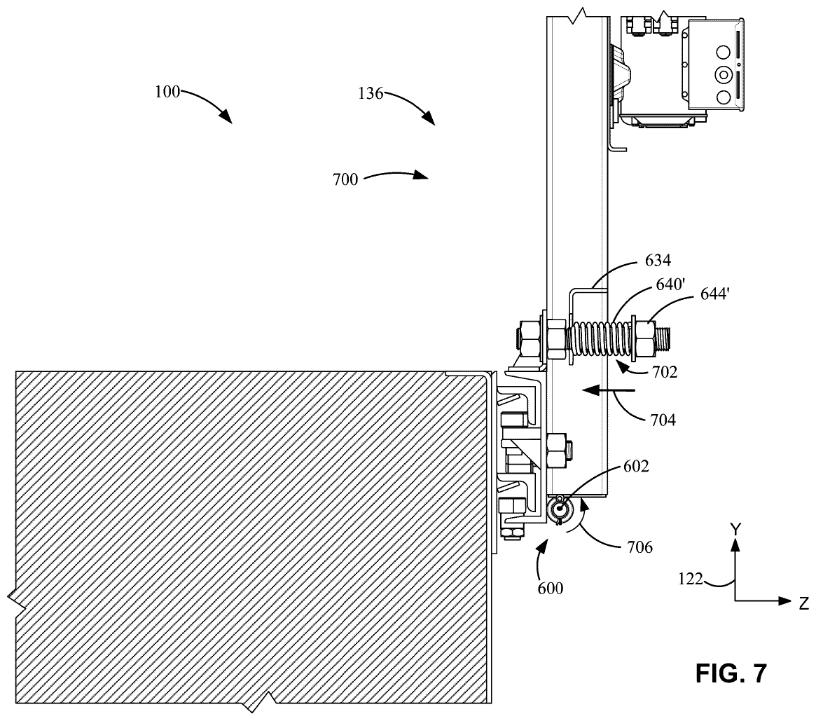

FIG. 7 is a cross-sectional view of the control panel 136. The control panel 136 of the illustrated example is shown in an example initial or non-deflected position 700. In the non-deflected position 700, the control panel 136 is in an upright orientation. Specifically, the control panel 136 is substantially vertical relative to the platform 108 and/or the front face 108a. For instance, the control panel 136 (e.g., the first post 506 and the second post 508) are substantially parallel relative to the front face 108a and/or vertical (e.g., the y-axis 112). As used herein, substantially parallel includes perfectly parallel or almost perfectly parallel. For example, in the non-deflected position 700, the control panel 136 can be at a small angle relative to vertical (e.g., the y-axis 112) between approximately 0.1 degrees and 10 degrees. For instance, a weight of the control panel 136 can cause the control panel 136 to deflect slightly (e.g., between 0.1 and 10 degrees) relative to vertical or the y-axis 112 when the control panel 136 is in the non-deflected position 700. In the non-deflected position 700, the springs 640, 640′ are in a first compressed state 702 between the support plate 634 and the respective fasteners 644, 644′ that apply a first force 704 against the support plate 634 to cause the control panel 136 to rotate in a first rotational direction 706 (e.g., a counterclockwise direction) about the pivot axis 602 of the pivot hinge 600 toward the carriage 406. As a result, the first post 506 and the second post 508 engage the front surface 716 of the carriage 406.

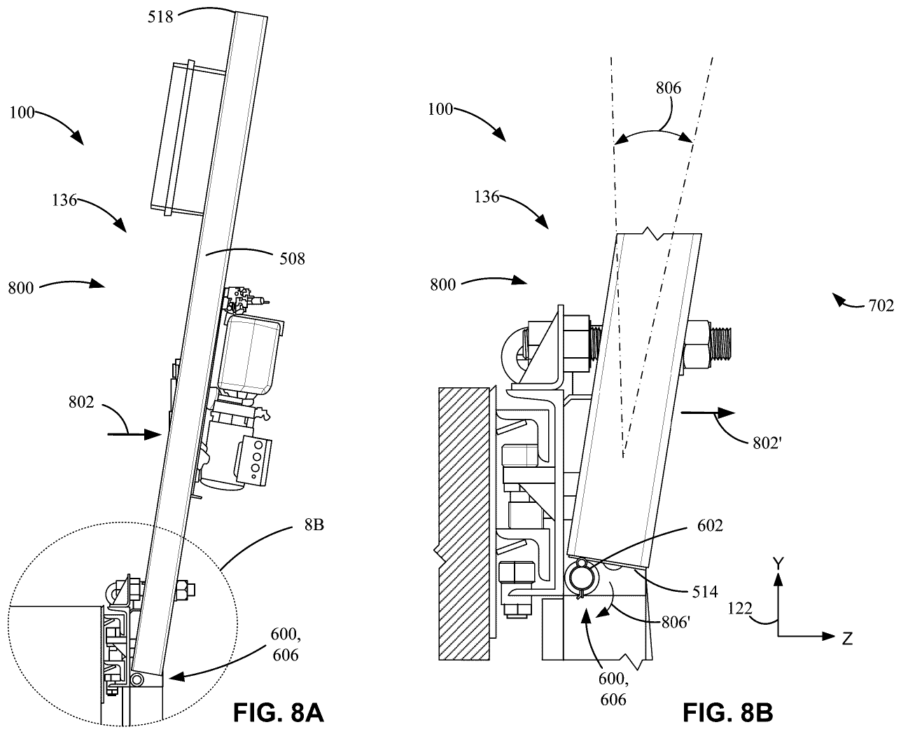

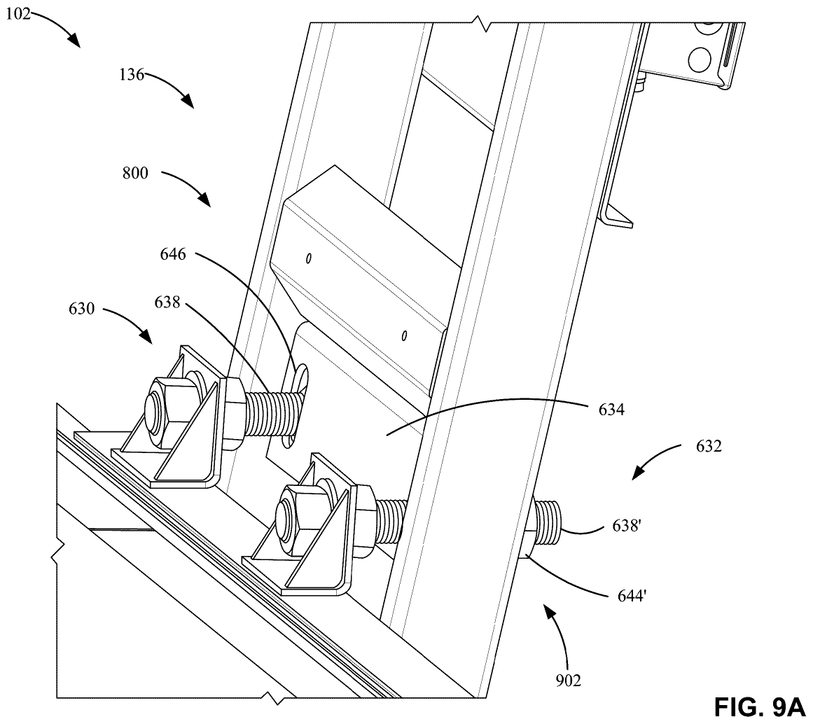

FIG. 8A is a side view of the control panel 136 shown in an example deflected position 800. FIG. 8B is a partial, enlarged view of FIG. 8A. Referring to FIG. 8B, in the deflected position 800, the control panel 136 pivots away from platform 108 and/or the carriage 406 via the pivot hinge 600 when an impact force (e.g., a horizontal force) is imparted to the control panel 136 in a second direction 802′ away from the platform 108. For example, a vehicle or fork truck can inadvertently engage the control panel 136 when traversing the platform 108. In conventional control panels that are rigidly coupled to the platform, such impact can cause damage to the control panel 136. However, the control panel 136 of the illustrated example deflects to dissipate such forces and reduce or eliminate damage to the control panel 136.

Specifically, the control panel 136 pivots or rotates in a second rotational direction 804 (e.g., a clockwise direction) about the pivot axis 602 of the pivot hinge 600 away from the carriage 406. In the deflected position 800, the first post 506 and the second post 508 detach from the front surface 716 (e.g., an outer surface) of the carriage 406. However, the first post 506 and the second post 508 remain attached and/or coupled to the carriage 406 via the pivot hinge 600. In other words, the second ends 516 and 518 of the respective first post 506 and the second post 508 swing or pivot relative to the pivot hinge 600 between the deflected position 800 and the non-deflected position 700 of FIG. 7. The first ends 512 and 514 of the respective first post 506 and the second post 508 remain attached to the carriage 406 via the first pivot hinge 604 and the second pivot hinge 606. In the deflected position 800, the control panel 136 can be an angle 806 relative to vertical or the y-axis 112 of between approximately 5 degrees and 70 degrees. After the impact force 802 is removed or dissipated, the control panel 136 of the illustrated example returns to the non-deflected position 700 of FIG. 7.

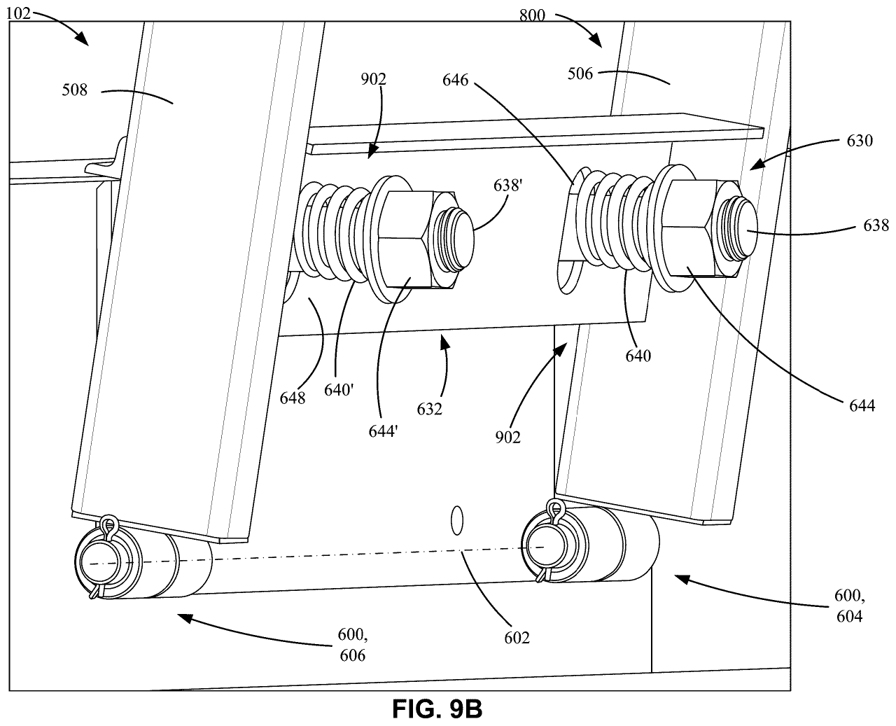

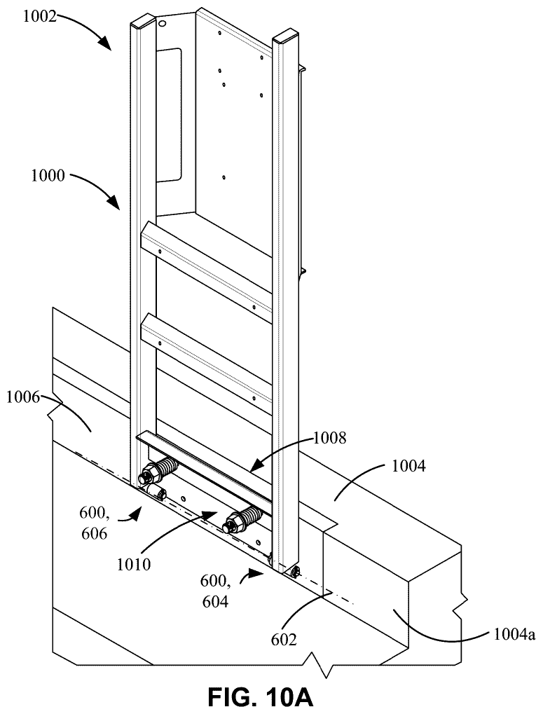

FIG. 9A is a perspective, rear view of the control panel 136 of FIG. 8A when in the deflected position 800. FIG. 9B is a perspective, front view of the control panel 136 of FIG. 8A when in the deflected position 800. When the control panel 136 is in the deflected position 800, the first spring 640 and the second spring 640′ are in a second compressed state 902. The second compressed state 902 is greater than the first compressed state 702 of FIG. 7. For instance, when the control panel 136 deflects to the deflected position 800, the support plate 634, being attached to the first post 506 and the second post 508 moves toward the fasteners 644 and 644′ of the respective first spring assembly 630 and the second spring assembly 632. In turn, the support plate 634 causes the first spring 640 and the second spring 640′ to compress to the second compressed state 902 (e.g., because the springs 640, 640′ are captured between the first side 634a of the support plate 634 and the respective second fastener 244 and the fourth fastener 244′). Additionally, the slots 646 and 648 of the support plate 634 enable the support plate 634 to slide relative to and/or along a longitudinal axis of the first screw 638 and the second screw 638′ (e.g., between the respective first ends 638a, 638a′ and the second ends 638b, 638b′). After the impact force 802 is removed or dissipated, the first spring 640 and the second spring 640′ return to the first compressed state 702. In turn, the first spring 640 and the second spring 640′ impart the force 704 against the support plate 634 to cause the support plate 634 and, thus, the control panel 136 to pivot in the first rotational direction 706 about the pivot axis 602 to the non-deflected position 700 of FIG. 7. In some examples, the control panel 136 is not coupled to the carriage 406. Instead, the control panel 136 can be attached directly to the platform 108 adjacent the carriage 406. For example, the control panel 136 disclosed herein can be attached to the front face 108a of the platform 108 via the pivot hinge 600.

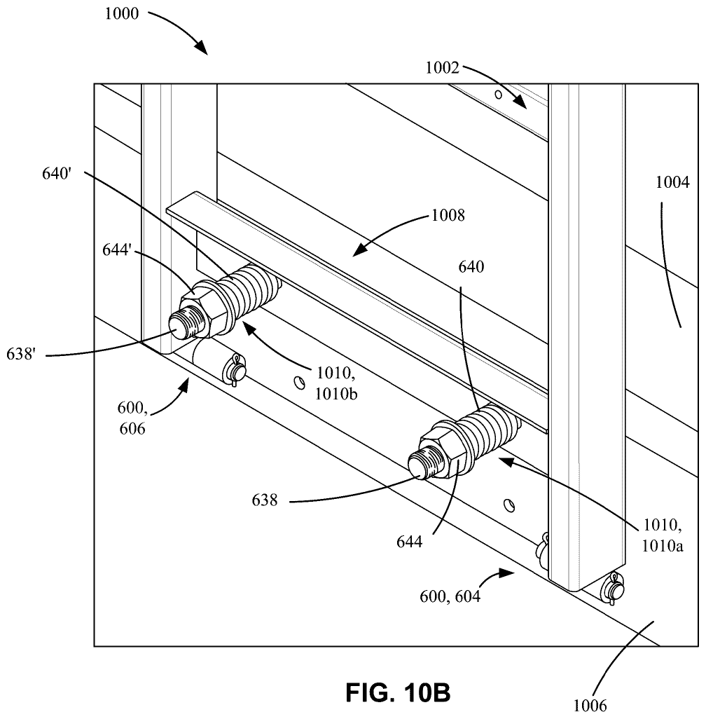

FIGS. 10A-10E are different views of another example loading dock 1000 including another example control panel 1002 disclosed herein. FIG. 10A is a perspective view of the loading dock 1000 and the control panel 1002. FIG. 10B is an enlarged, partial view of FIG. 10A. FIG. 10C is a perspective, rear view of the loading dock 1000 and the control panel 1002. FIG. 10D is a top view of the control panel 1002 and the loading dock 1000. FIG. 10E is a partial, perspective view of the control panel 1002. Many of the components of the example loading dock 1000 and/or control panel 1002 are substantially similar or identical to the components described above in connection with FIGS. 1-4. As such, those components will not be described in detail again below. Instead, the interested reader is referred to the above corresponding descriptions for a complete written description of the structure and operation of such components. To facilitate this process, similar or identical reference numbers will be used for like structures in FIGS. 10A-10E as used in FIGS. 1-9B. For instance, the control panel 1002 includes a first post 506, a second post 508, and a pivot hinge 600.

Referring to FIGS. 10A-10D, the control panel 1002 is coupled to (e.g., directly coupled or mounted to) a platform 1004 (i.e., instead of a carriage (e.g., the carriage 406)). The control panel 136 of the illustrated example is attached to the platform 1004 (e.g., a vertical wall 1004a) via a mounting plate 1006 (e.g., a fixed mounting plate). The mounting plate 1006 fixes a lateral position of the control panel 136. Thus, the control panel 1002 of FIG. 10A cannot move in the first direction 114 (e.g., a lateral direction of FIGS. 1-4). However, the control panel 1002 is pivotally coupled to the platform 1004 via a deflection system 1008.

The deflection system 1008 of the illustrated example includes a pivot hinge 600 and a biasing assembly 1010. In particular, the control panel 1002 of the illustrated example is pivotally coupled to the platform 1004 via the pivot hinge 600 and can pivot about the pivot axis 602. The pivot hinge 600 of the illustrated example is substantially similar to the pivot hinge 600 of FIG. 6 except that the pivot hinge 600 is coupled to the mounting plate 1006.

Additionally, the biasing assembly 1010 biases the control panel 1002 to the upright orientation. The biasing assembly 1010 is substantially similar to the biasing assembly 610 of FIGS. 6A-6C except the mounting brackets 636, 636′ and the fasteners 642, 642′ are omitted. Instead, the biasing assembly 1010 of the illustrated example includes a first spring assembly 1010a and a second spring assembly 1010b. The first spring assembly 1010a has a first bolt or screw 638, a first spring 640, a fastener 644 and a first mounting fastener 1012a. The second spring assembly 1010b has a second bolt or screw 638′, a second spring 640′, a second fastener 644′ and a second mounting fastener 1012b. The mounting fasteners 1012a, 1012b (e.g., threaded nuts, etc.) are coupled or attached to the mounting plate 1006 and/or the vertical wall 1004a of the loading dock 1100 to receive respective ones of the screws 638, 638′. The fasteners 1012 are positioned between a support plate 634 of the biasing assembly 1010 and the mounting plate 1006 and/or the vertical wall 1004a. In operation, the pivot hinge 600 and the biasing assembly 1010 enables the control panel 1002 to pivot relative to the platform 1004 when impacted by a vehicle. In other words, the mounting plate 1006 does not impede operation of the deflection system 1008. Thus, the deflection system 1008 of the control panel 1002 of the illustrated example enables the control panel 1002 to pivot relative to the platform 1004 about the pivot axis 602 defined by the pivot hinge 600.

Referring to FIG. 10E, a stop or rubber fixture 1014 can be attached to the mounting plate between the control panel 1002 and the mounting plate 1006 to reduce impact when the control panel 1002 moves toward the non-deflected position 700 or upright orientation.

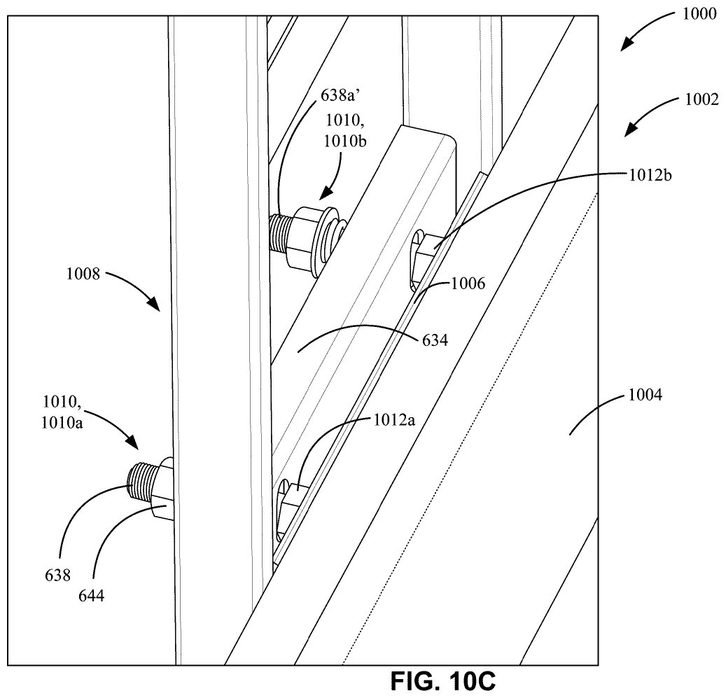

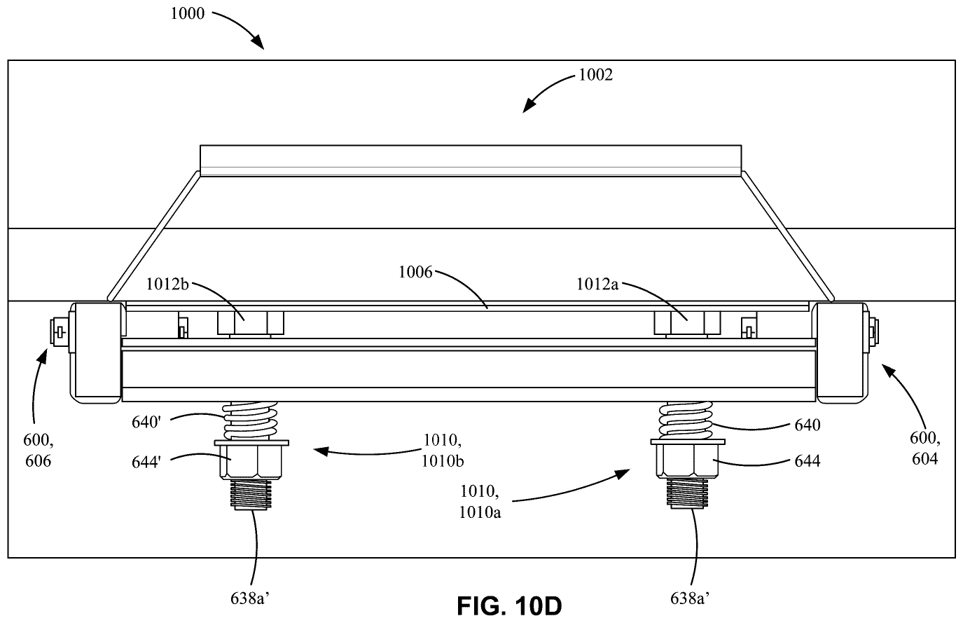

FIG. 11A is a perspective view of an example loading dock 1100 having another example control panel 1102 disclosed herein. FIG. 11B is another perspective view of the example loading dock 1100 of FIG. 11A. Many of the components of the example loading dock 1100 and/or control panel 1102 are substantially similar or identical to the components described above in connection with FIGS. 1-10E. As such, those components will not be described in detail again below. Instead, the interested reader is referred to the above corresponding descriptions for a complete written description of the structure and operation of such components. To facilitate this process, similar or identical reference numbers will be used for like structures in FIGS. 11A and 11B as used in FIGS. 1-10E. For instance, the control panel 1102 includes a first post 506, a second post 508 and a biasing assembly 1010 (e.g., a spring or biasing system of FIGS. 10A-10E).

Referring to FIGS. 11A and 11B, the control panel 1102 of the illustrated example is mounted to a face 1104 (e.g., a vertical wall) of a platform 1106 of the loading dock 1100. Specifically, the control panel 1102 is coupled to (e.g., directly coupled or mounted to) the face 1104 (e.g., a vertical wall) via a mounting plate 1108 (e.g., a fixed mounting plate). Specifically, the control panel 1102 is pivotally and slidably coupled relative to the face 1104 and/or the platform 1106. To pivotally and slidably couple the control panel 1102 relative to the platform 1106, the control panel 1102 of the illustrated example includes a deflection system 1110. The deflection system 1110 of the illustrated example includes a pivot hinge 1112 and a biasing assembly 1010.

The pivot hinge 1112 of the illustrated example enables the control panel 1102 to pivot relative to the face 1104 about a pivot axis 602 and slidably or laterally move relative to the face 1104 in a first direction 114 along a pivot axis 1114 of the pivot hinge 1112. The first direction 114 of the illustrated example is substantially parallel relative to the face 1104 of the platform 1106. The biasing assembly 610 biases the control panel 1102 to the upright orientation. The pivot hinge 1112 and the biasing assembly 1010 enable the control panel 1102 to pivot relative to the platform 1106 about the pivot axis 1114 and/or slide along the pivot axis 1114 in the first direction 114 when impacted by a vehicle. In other words, the mounting plate 1108 does not impede operation of the deflection system 1110.

The pivot hinge 1112 of the illustrated example includes a first pivot hinge 1116 and a second pivot hinge 1118. The first pivot hinge 1116 pivotally couples the first post 506 and the mounting plate 1108 and the second pivot hinge 1118 pivotally couples the second post 508 and the mounting plate 1108. Although the pivot hinge 1112 of the illustrated example includes the first pivot hinge 1116 and the second pivot hinge 1118, the first pivot hinge 1116 and the second pivot hinge 1118 enable the first post 506 and the second post 508 to move or pivot simultaneously relative to the mounting plate 1108 about the pivot axis 1114 because the first post 506 is coupled to the second post 508 via a panel (e.g., the panel 510), a support plate 1120 and/or the biasing assembly 610.

The first pivot hinge 1116 (e.g., a piano hinge) of the illustrated example includes a first knuckle 1122, a second knuckle 1124 and a first biasing element or spring 1126. The second pivot hinge 1118 (e.g., a piano hinge) of the illustrated example includes a third knuckle 1128, a fourth knuckle 1130 and a second biasing element or spring 1132. A pin or rod 1134 slidably couples the first pivot hinge 1116 and the second pivot hinge 1118.

The first knuckle 1122 of the first pivot hinge 1116 is coupled to the mounting plate 1108. Specifically, the first knuckle 1122 is attached to a front surface 1108a of the mounting plate 1108. The first knuckle 1122 is attached or fixed to the mounting plate 1108 via, for example, welding. The second knuckle 1124 is coupled to the first post 506. In this example, the second knuckle 1124 is attached or fixed (e.g., welded) to an end surface 618 of a first end 512 of the first post 506. The rod 1134 maintains alignment of the first knuckle 1122 and the second knuckle 1124 relative to the pivot axis 602 to enable the first post 506 to pivot relative to the platform 1106 about the pivot axis 602.

The third knuckle 1128 of the second pivot hinge 1118 is coupled to the mounting plate 1108. Specifically, the third knuckle 1128 is attached to the front surface 1108a of the mounting plate 1108. The third knuckle 1128 is attached or fixed to the mounting plate 1108 via, for example, welding. The fourth knuckle 1130 is coupled to the second post 508. In this example, the fourth knuckle 1130 is attached or fixed (e.g., welded) to an end surface 626 of a first end 514 of the second post 508. The rod 1134 maintains alignment of the third knuckle 1128 and the fourth knuckle 1130 relative to the pivot axis 602 to enable the second post 508 to pivot relative to the platform 1106 about the pivot axis 602.

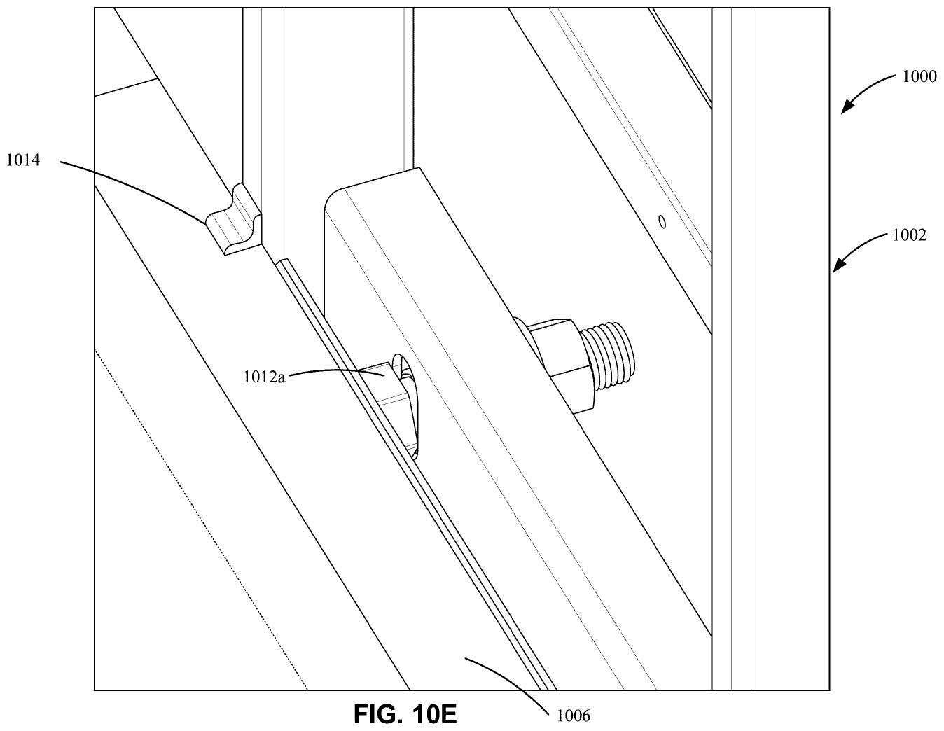

FIG. 12 is a rear view of the example control panel 1102 of FIGS. 11A and 11B. Referring to FIG. 12, the support plate 1120 of the illustrated example extends between the first post 506 and the second post 508. The support plate 1120 includes a first opening 1202 and a second opening 1204 to receive a first spring assembly 1010a and a second spring assembly 1010b of the biasing assembly 1010. Specifically, the first opening 1202 and the second opening 1204 are substantially similar to the slots 648 and 646 of FIGS. 6A and 6B except that the first opening 1202 and the second opening 1204 of the illustrated example have an oblong, oval or ellipsoidal shape. Specifically, a major axis of the first opening 1202 and the second opening 1204 is substantially horizontal or parallel relative to the pivot axis 1114 and a minor axis of the first opening 1202 and the second opening 1204 is substantially vertical or perpendicular relative to the pivot axis 1114. In other words, the first opening 1202 and the second opening 1204 have elongated shapes in a horizontal orientation or along the pivot axis 1114 to enable the control panel 1102 to slide side-to-side in the first direction 114 relative to the platform 1106. In some examples, the first opening 1202 and the second opening 1204 can be replaced by an elongated slot (e.g., a slot extending between or connecting the first opening 1202 and the second opening 1204).

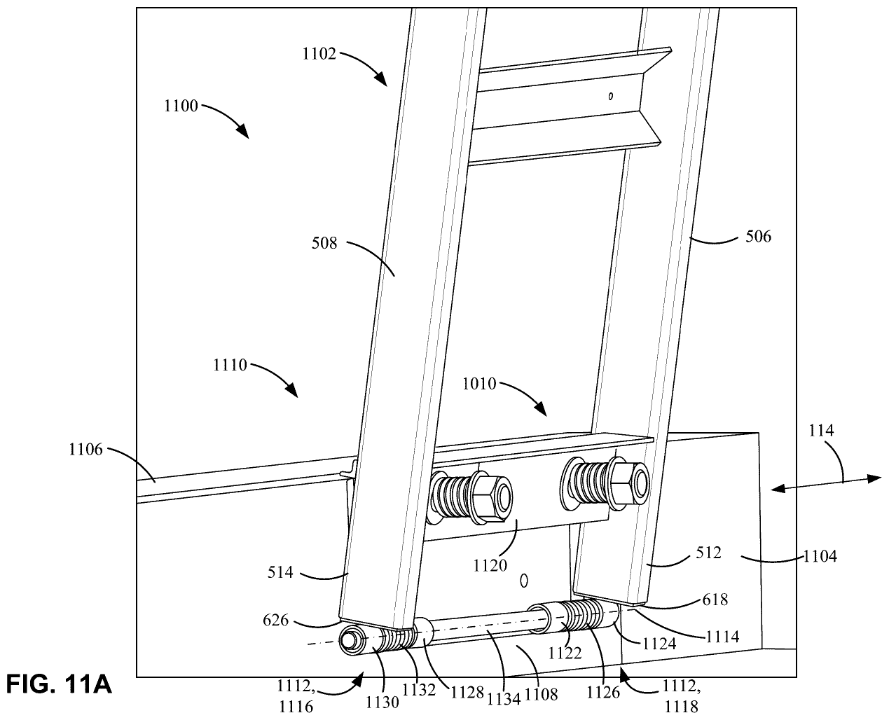

FIG. 13 is a partial front view of the control panel 1102 in a first example position 1300. In operation, the biasing assembly 1010 of the illustrated example maintains the control panel 1102 in a non-deflected or an upright orientation (e.g., the non-deflected position 700 of FIG. 7). For example, the biasing assembly 1010 of the illustrated example biases the control panel 1102 about the pivot axis 1114 in a direction toward the platform 1106. In this manner, the first ends 512, 514 of the respective first post 506 and the second post 508 are biased into engagement (e.g., direct contact) with the platform 1106. In response to an impact event, the biasing assembly 610 enables the control panel 1102 to pivot about the pivot axis 1114 in a direction away from the platform 1106. When the control panel 1102 is deflected or pivoted about the pivot axis 1114 in a direction away from the platform 1106, the biasing assembly 610 causes the control panel 1102 to return to the upright orientation after a force from an impact event is removed from the control panel 1102.

Additionally, the first spring 1126 and the second spring 1132 (e.g., a lateral spring assembly) of the pivot hinge 1112 of the illustrated example maintains the control panel 1102 in a non-impact, lateral position 1302. For example, the first spring 1126 and the second spring 1132 of the pivot hinge 1112 centers the control panel 1102 relative to a vertical center reference line 1304. In other words, a center 1306 (e.g., a vertical center) of the control panel 1102 aligns with the vertical center reference line 1304 during a non-impact event.

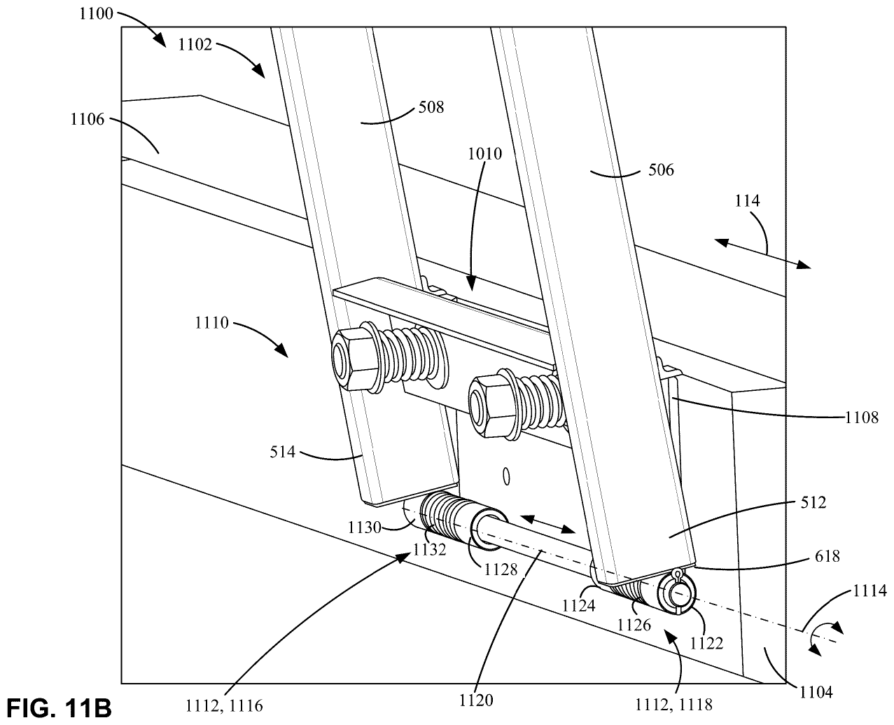

FIG. 14 is a partial front view of the control panel 1102 in a laterally deflected position 1400. During an impact event, the pivot hinge 1112 provides a slider to enable the control panel 1102 to slide in the first direction 114 relative to the platform 1106. For example, in response to a lateral force imparted to the control panel 1102 during an impact event, the control panel 1102 can slide along the rod 1134 laterally in the first direction 114 (e.g., a bidirectional direction). For example, in the illustrated example, a lateral force 1402 imparted to the first post 506 causes the control panel 1102 to shift or slide along the pivot axis 1114 and/or the rod 1134 in a first lateral direction 1404. As a result, the second knuckle 1124 (FIG. 11A) slides along the rod 1134 to compress the first spring 1126 against the first knuckle 1122, which is fixed to the mounting plate 1108. Thus, the first knuckle 1122 does not slide relative to the platform 1106 and/or the mounting plate 1108 and the second knuckle 1124 can slide along the rod 1134 relative to the platform 1106 and/or the mounting plate 1108. Likewise, the fourth knuckle 1130 (FIG. 11B) moves in the first lateral direction 1404 away from the third knuckle 1128, which is fixed to the mounting plate 1108. Thus, the third knuckle 1128 does not slide relative to the platform 1106 and/or the mounting plate 1108 and the fourth knuckle 1130 can slide along the rod 1134 relative to the platform 1106 and/or the mounting plate 1108. Additionally, the first opening 1202 and the second opening 1204 of the support plate 1120 enables the control panel 1102 to shift in the first lateral direction 1404. The first knuckle 1122 and the third knuckle 1128 remain fixed to the mounting plate 1108. In other words, the center 1306 (e.g., a vertical center) of the control panel 1102 is offset relative to the vertical center reference line 1304 by a distance 1406 (e.g., a maximum lateral distance) during an impact event. In some examples, the distance 1406 can be limited by the openings 1202, 1204. In some examples, the support plate 1120 can include an elongated slot to increase an amount of the distance 1406. After the lateral force 1402 from the impact event is removed from the control panel 1102, the first spring 1126 and the second spring 1132 (e.g., a lateral spring assembly) of the pivot hinge 1112 of the illustrated example causes the control panel 1102 (e.g., the second knuckle 1124 and the fourth knuckle 1130) to return to the non-impact, lateral position 1302 of FIG. 13 (e.g., such that the center 1306 of the control panel 1102 aligns with the vertical center reference line 1304). The control panel 1102 is not limited to direct coupling to a platform. In some examples, the control panel 1102 can be coupled to the carriage 406 of FIG. 4.

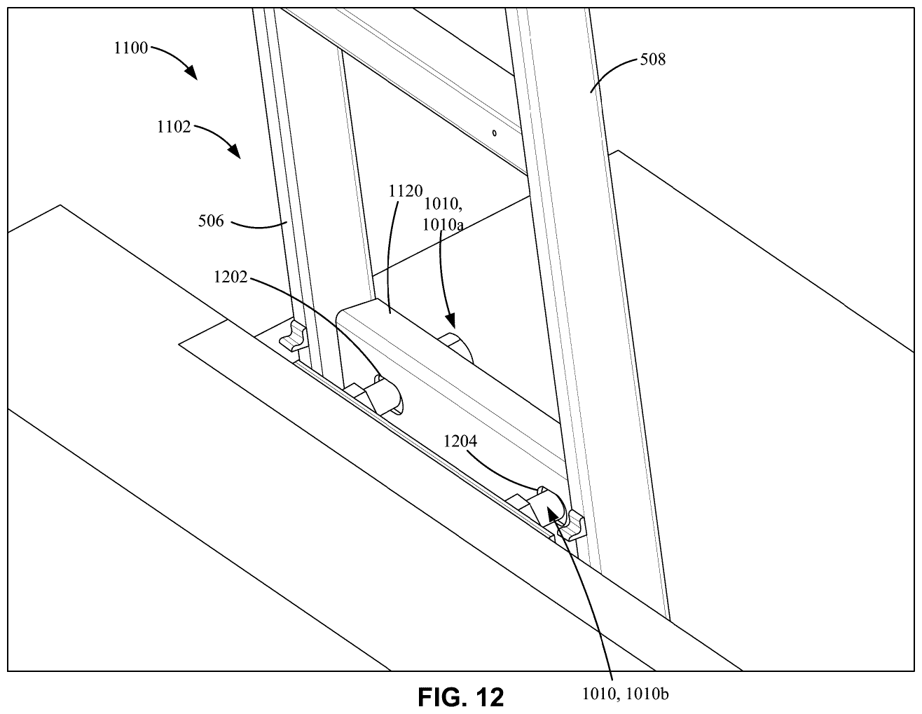

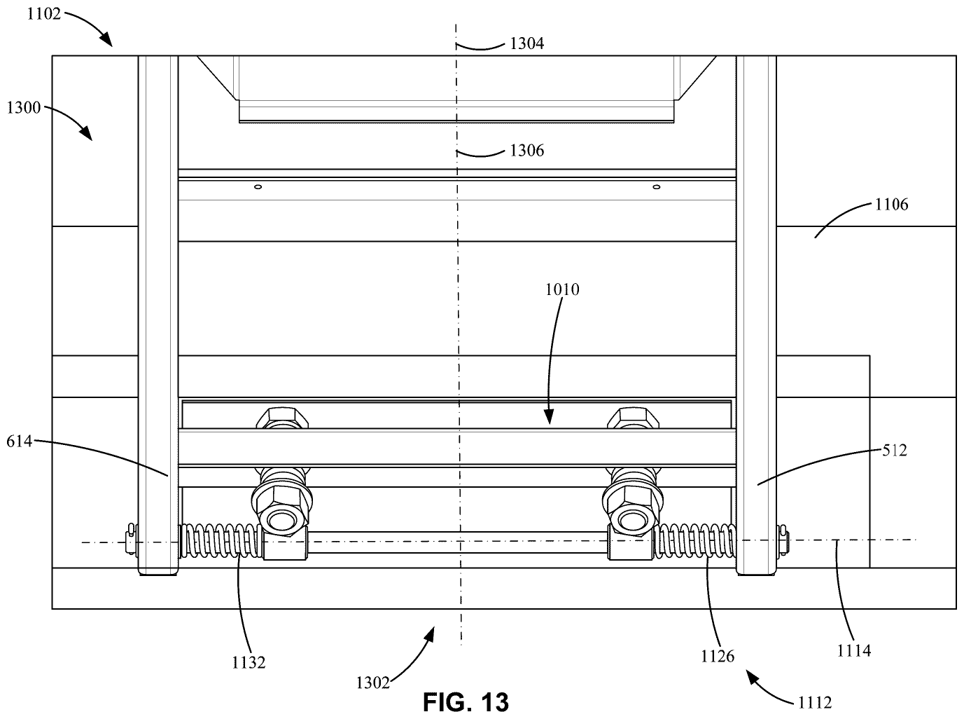

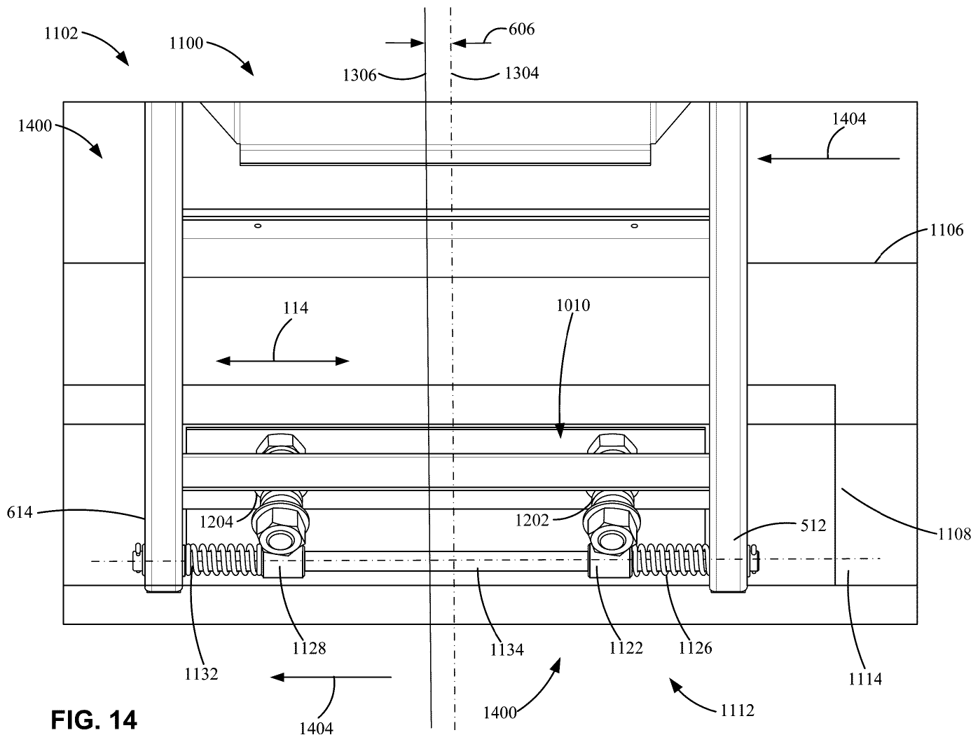

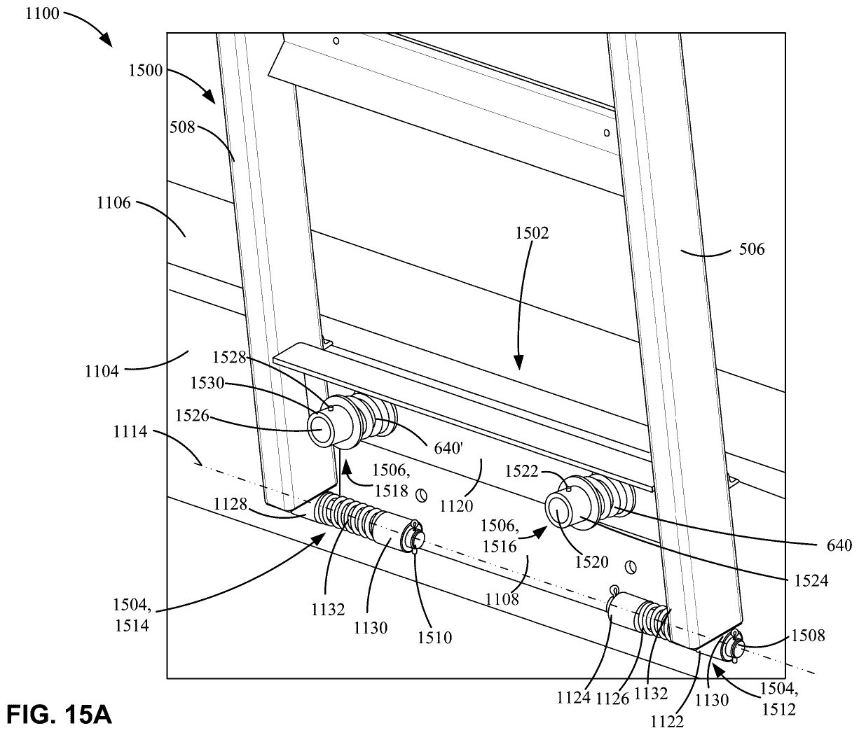

FIG. 15A is a perspective view of another example control panel 1500 disclosed herein. FIG. 15B is another perspective view of the example control panel 1500 of FIG. 15A. FIG. 15C is a perspective, rear view of the example control panel 1500 of FIGS. 15A and 15B. FIG. 15D is a side view of the example control panel 1500 of FIGS. 15A and 15B. Many of the components of the example control panel 1500 are substantially similar or identical to the components described above in connection with FIGS. 1-14. As such, those components will not be described in detail again below. Instead, the interested reader is referred to the above corresponding descriptions for a complete written description of the structure and operation of such components. To facilitate this process, similar or identical reference numbers will be used for like structures in FIGS. 15A-15D as used in FIGS. 1-14. For instance, the control panel 1500 includes a first post 506, a second post 508, and a support plate 1120.

Referring to FIGS. 15A-15D, the control panel 1500 of the illustrated example is mounted to a face 1104 (e.g., a vertical wall) of a platform 1106 of a loading dock 1100. The control panel 1500 is coupled to (e.g., directly coupled or mounted to) the face 1104 (e.g., a vertical wall) via a mounting plate 1108 (e.g., a fixed mounting plate). Specifically, the control panel 1500 is pivotally and slidably coupled relative to the face 1104 and/or the platform 1106. To pivotally and slidably couple the control panel 1500 relative to the platform 1106, the control panel 1500 of the illustrated example includes a deflection system 1502. The deflection system 1502 of the illustrated example includes a pivot hinge 1504 and a biasing assembly 1506.

The pivot hinge 1504 is substantially similar to the pivot hinge 1112 of FIGS. 11A and 11B except the rod 1134 is omitted and replaced by a first pivot pin or rod 1508 and a second pivot pin or rod 1510. For example, the pivot hinge 1504 of the illustrated example includes a first pivot hinge 1512 and a second pivot hinge 1514. The first pivot hinge 1512 (e.g., a piano hinge) of the illustrated example includes a first knuckle 1122, a second knuckle 1124, a first biasing element or spring 1126, and the first pin 1508. The first pin 1508 pivotally and slidably couples the first pivot hinge 1512 relative to the platform 1106 and/or the loading dock 1100 and maintains alignment of the first knuckle 1122 and the second knuckle 1124 relative to a pivot axis 1114. The second pivot hinge 1514 (e.g., a piano hinge) of the illustrated example includes a third knuckle 1128, a fourth knuckle 1130, a second biasing element or spring 1132, and the second pin 1510. The second pin 1510 pivotally and slidably couples the second pivot hinge 1514 relative to the platform 1106 and/or the loading dock 1100 and maintains alignment of the third knuckle 1128 and the fourth knuckle 1130 relative to the pivot axis 1114.

The biasing assembly 1506 of the illustrated example interacts with a support plate 1120 of the control panel 1500. The biasing assembly 1506 of the illustrated example is substantially similar to the biasing assembly 1010 of FIGS. 11A and 11B except the screws 638, 638′ and the fasteners 1012a, 1012b are omitted. The biasing assembly 1506 of the illustrated example includes a first spring assembly 1516 and a second spring assembly 1518. The first spring assembly 1518 has a first rod 1520, a first shear pin 1522, a first spring 640, a first retainer 1524. The first shear pin 1522 extends through an opening in the first retainer 1524 and the first rod 1520 to couple the first retainer 1524 and the first rod 1520. The first retainer 1524 retains the first spring 640 coupled to the first rod 1520 between the first retainer 1524 and the support plate 1120. Additionally, the first rod 1520 of the illustrated example is a non-threaded fastener and is welded to the mounting plate 1108.

The second spring assembly 1520 has a second rod 1526, a second shear pin 1528, a second spring 640′ and a second retainer 1530. The second retainer 1530 retains the second spring 640′ coupled to the second rod 1526 between the second retainer 1530 and the support plate 1120. The second shear pin 1528 extends through an opening in the second retainer 1530 and the second rod 1526 to couple the second retainer 1530 and the second rod 1526. The second rod 1526 of the illustrated example is a non-threaded fastener and is welded to the mounting plate 1108. In operation, the shear pins 1522, 1528 can shear or break when an amount of force applied to the control panel 1500 exceeds a threshold force. In this manner, damage to the platform 1106 (the vertical wall 1106a) can be prevented or reduced.

The example loading bay 100, the ramp mover 134, the control panel 136, the loading dock 1000, the control panel 1002, the loading dock 1100, the control panel 1102 and/or the control panel 1500 is not limited to railcar ramp systems, warehouses, etc. For example, the control panels 136, 1002, 1102, 1500 disclosed herein can be coupled a loading dock to receive a vehicle, a warehouse, an interior of a building, an exterior of a building, and/or any other structure. In some examples, the control panel 136, the control panel 1002, the control panel 1102, and/or the control panel 1500 disclosed herein can be coupled to a loading dock and/or any other structure of a loading dock located outside of the loading dock or warehouse or inside of a loading dock or warehouse. For example, the control panel 136 the control panel 1002, the control panel 1102, and/or the control panel 1500 can be attached inside a warehouse where material handling equipment can impact or accidentally hit the control panel.

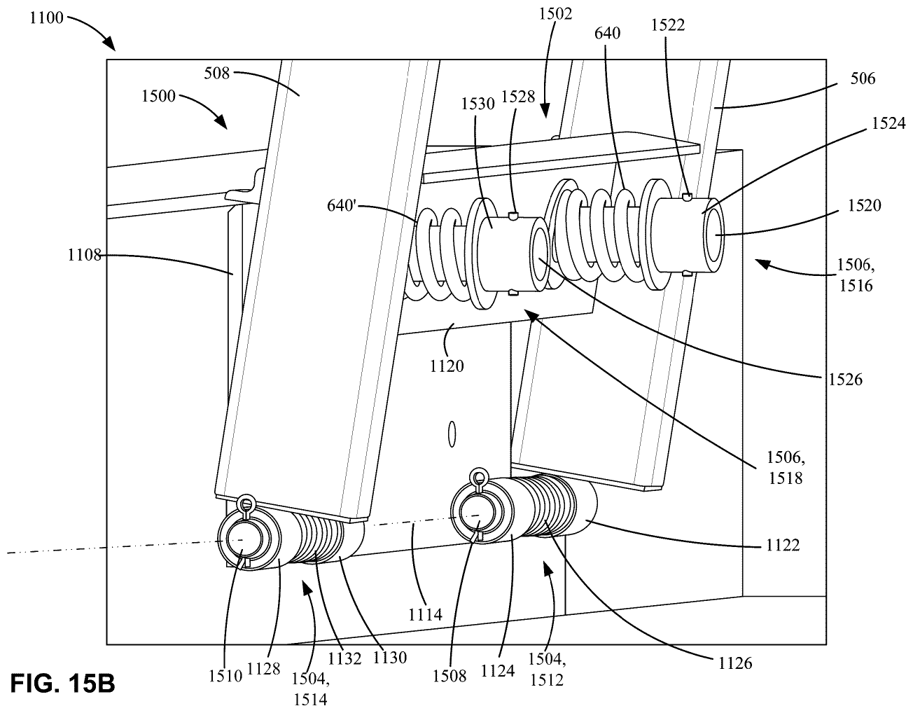

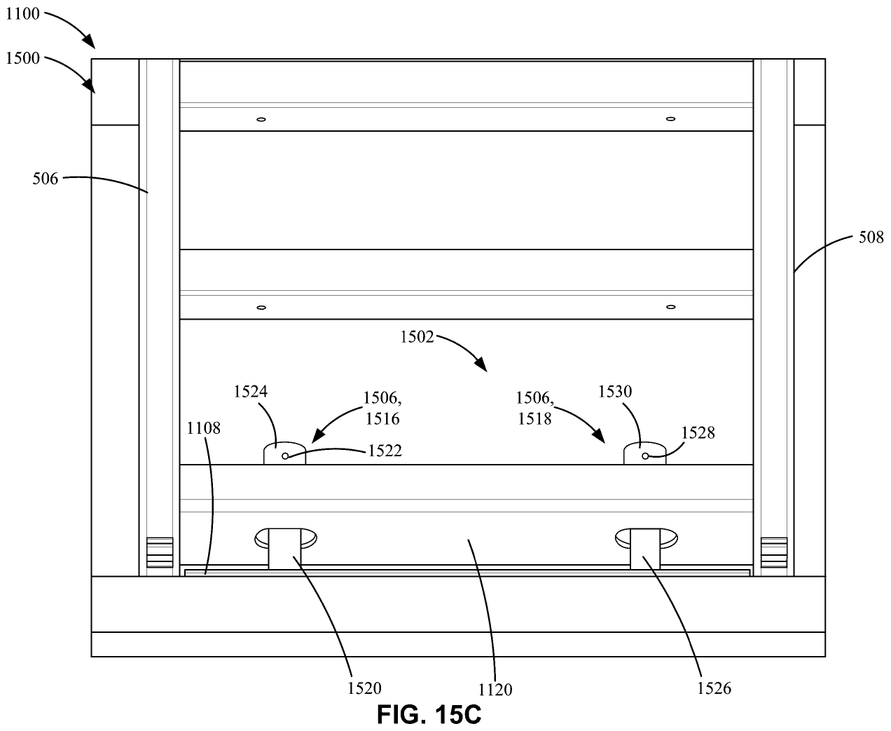

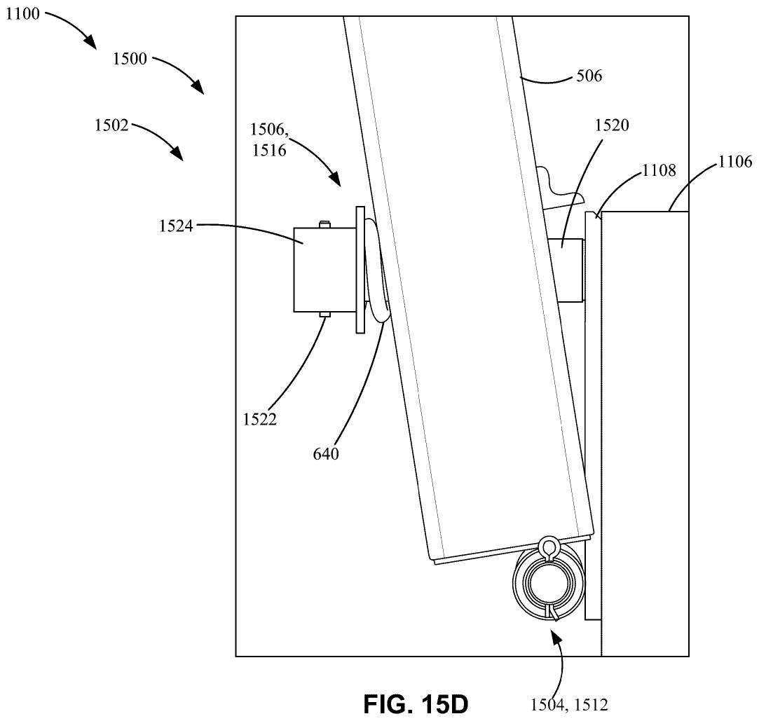

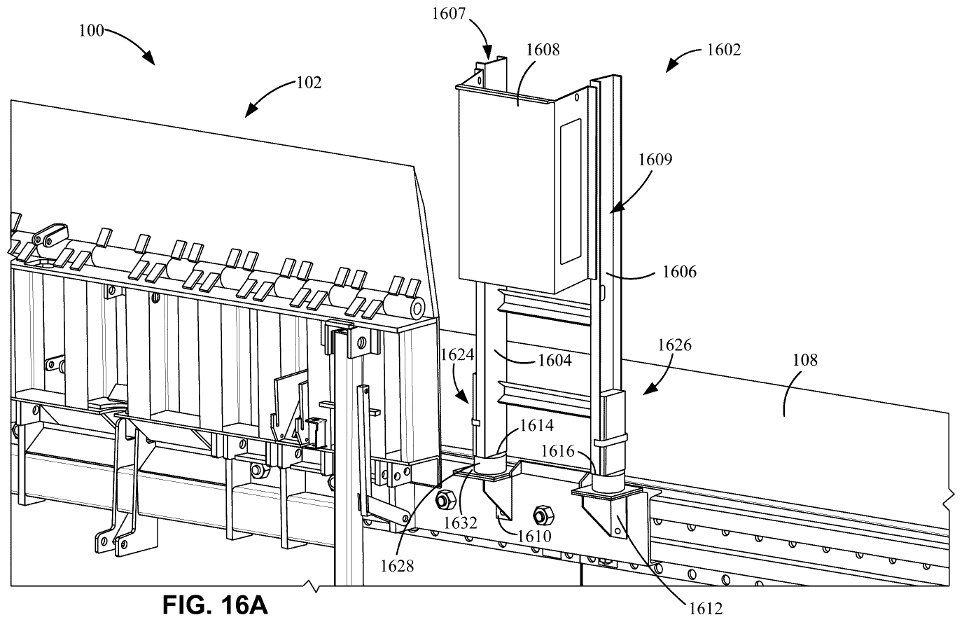

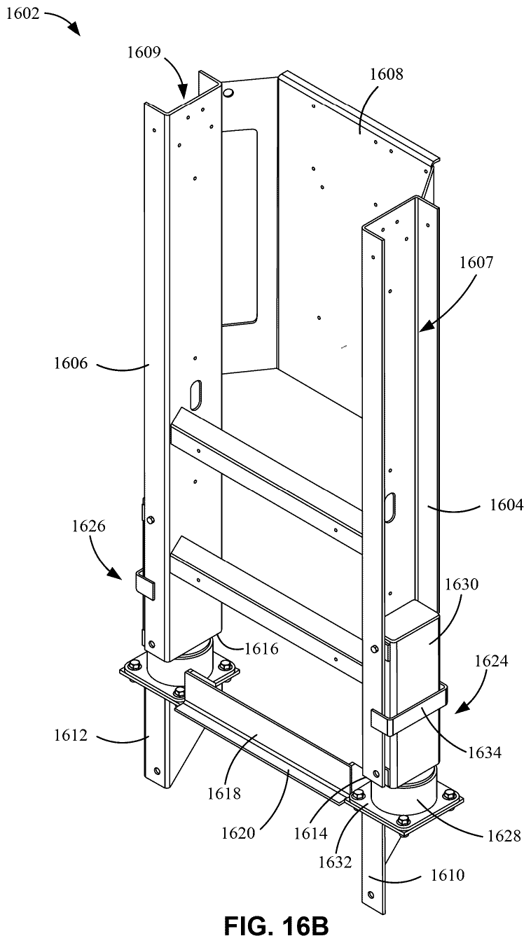

FIG. 16A is a front perspective view of another example railcar ramp system 1600 similar to FIG. 11, but showing a rear perspective view of a different example control panel 1602. FIG. 16B is a front perspective view of the example control panel 1602 of FIG. 16A with the surrounding structure of the railcar ramp system 1600 removed for the sake of clarity. FIG. 16C is a rear view of the example control panel 1602 of FIG. 16B. FIG. 16D is a top view of the example control panel 1602 of FIG. 16B. FIG. 16E is a bottom view of the example control panel 1602 of FIG. 16B. Many of the components of the railcar ramp system 1600 and/or control panel 1602 are substantially similar or identical to the components described above in connection with FIGS. 1-15D. As such, those components will not be described in detail again below. Instead, the interested reader is referred to the above corresponding descriptions for a complete written description of the structure and operation of such components.

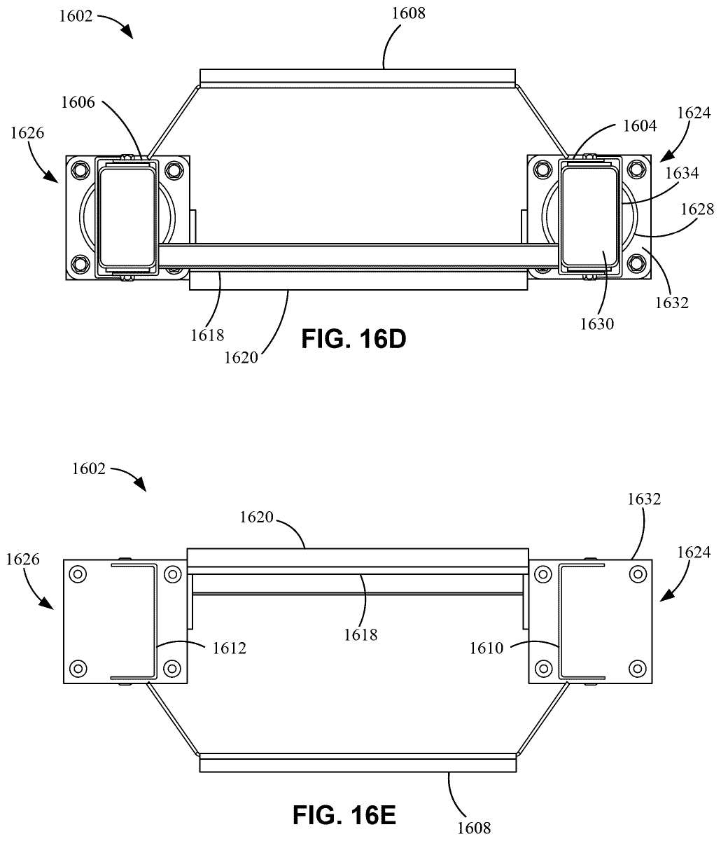

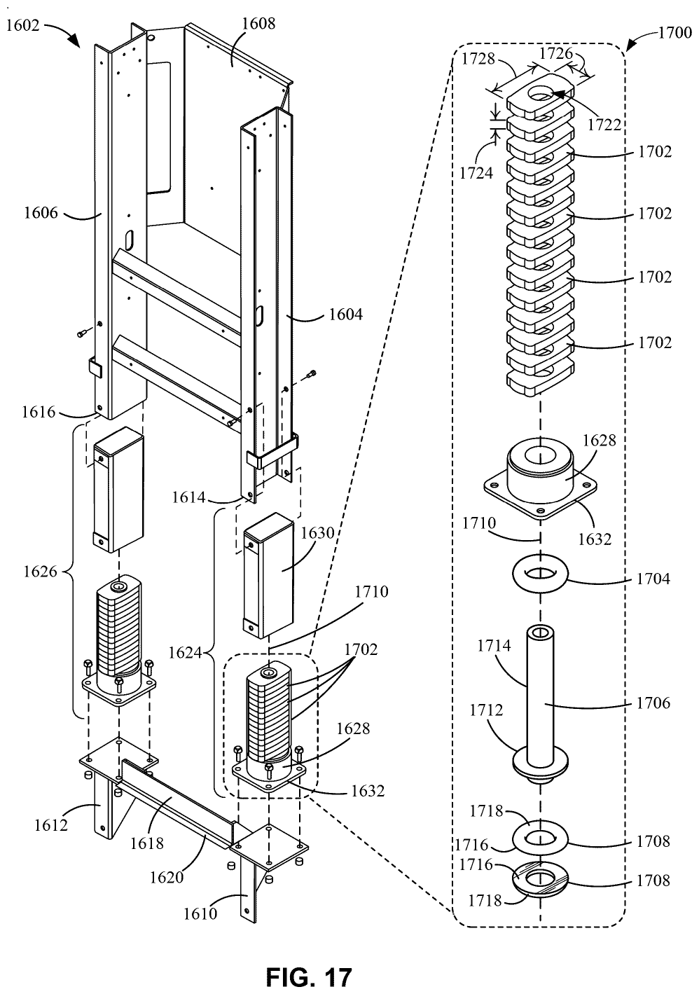

In the illustrated example of FIG. 16A-16E, the control panel 1602 includes a first post 1604 (e.g., a beam, a mast, etc.), a second post 1606 (e.g., a beam, a mast, etc.), and a panel 1608 (e.g., a plate, sheet metal, a board, etc.). In this example, the first and second posts 1604, 1606 have a C-shaped cross-section to define an internal channel 1607, 1609 that extends along the length of the posts 1604, 1606. In other examples, the posts 1604, 1606 can have a different cross-sectional shape (e.g., a rectangle with an enclosed internal channel). The panel 1608 is coupled to the first post 506 and the second post 508 to span a distance therebetween. In some examples, a control box (e.g., the control box 414 of FIGS. 4 and 5) and/or other electronic components (e.g., the electronic components 502 of FIG. 5) are mounted to and/or otherwise supported by the panel 1608 and/or the posts 1604, 1606. Unlike the control 136, 1002, 1102, 1500 of FIGS. 1-15D that are coupled to the carriage 406 via a hinge, the example control panel 1602 is rigidly affixed to the carriage 406 as shown in FIG. 16A. More particularly, the control panel 1602 includes first and second braces 1610, 1612 (adjacent respective first ends 1614, 1616 of the respective first and second posts 1604, 1606) that are rigidly affixed (e.g., via threaded fasteners, an adhesive, welding, etc.) to the carriage 406. In some examples, the control panel 1602 includes a crossbeam 1618 between the braces that includes a lip 1620 or other portion that rests on (e.g., engages with) a top surface 1622 of the carriage 406 (shown most clearly in FIG. 18A). In some examples, the lip 1620 is also rigidly affixed (e.g., via threaded fasteners, an adhesive, welding, etc.) to the carriage 406.

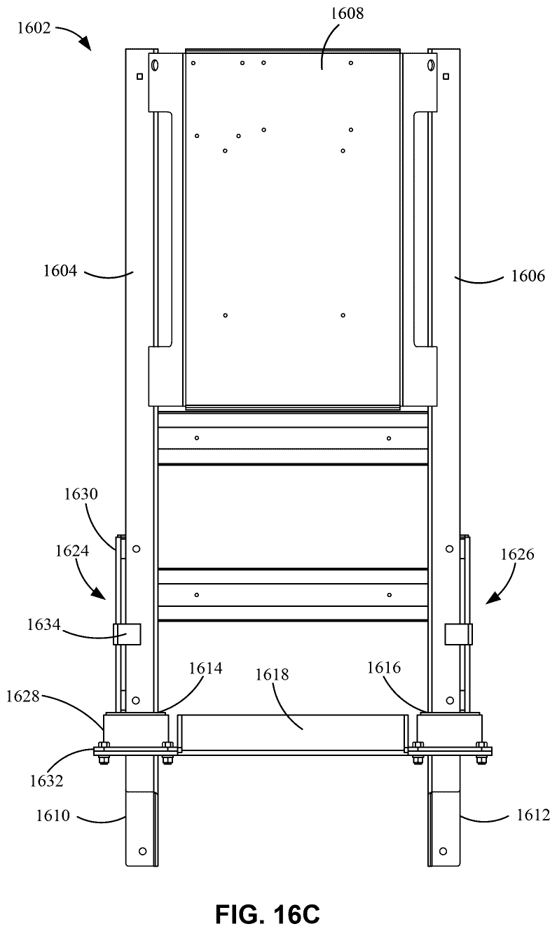

As shown in FIGS. 16A and 16B, the first and second posts 1604, 1606 of the control panel 1602 are physically decoupled from (e.g., indirectly coupled to, spaced apart from) the first and second braces 1610, 1612 by respective first and second deflection systems 1624, 1626 that configure the control panel 136 as an impactable mast, post, beam, or other structure. In this example, the first and second deflection systems 1624, 1626 are substantially the same or identical. Accordingly, only the first deflection system 1624 will be described in detail, but the description applies equally to the second deflection system 1626. The example first deflection system 1624 includes an example anchor 1628 (e.g., a base) and an example casing 1630 (e.g., housing, covering, box). As shown in FIGS. 16A and 16B, the example anchor 1628 of the first deflection system 1624 is couplable (e.g., mountable) to the first brace 1610 via threaded fasteners extending through a mounting flange 1632 of the anchor 1628. The first post 1604 is situated above (e.g., rests on) a top surface of the anchor 1628 with the casing 1630 positioned within the internal channel 1607 of the first post 1604. More particularly, as shown in FIGS. 16A and 16B, the casing 1630 is positioned within the channel 1607 adjacent the first end 1614 of the first post 1604. Thus, in some examples, the casing 1630 is also in contact with (e.g., rests on) the top surface of the anchor 1628. In other examples, the casing 1630 is at least slightly offset relative to the first end 1614 of the first post 1604 to be spaced apart from the anchor 1620. In some examples, the casing 1630 is secured in place within the internal channel 1607 via one or more fasteners extending through the post 1604 and the casing 1630. Further, in some examples, a support strap 1634 extends around the casing 1630 to help hold the casing 1630 in place within the channel 1607. In this example, the support strap is a strip of metal affixed (e.g., via welding, an adhesive, fasteners, etc.) to the first post 1604. In other examples, the support strap 1634 can be a more flexible and/or elastic material. In some examples, the casing 1630 is integrally formed with the first post 1607. In the illustrated, the height of the casing 1630 is significantly less than the height of the first post 1604. However, the casing 1630 can be any suitable height to contain the internal components of the deflection system 1626 as shown and described in connection with FIG. 17. In some examples, the casing 1630 has a height similar to the height of the first post 1604.

FIG. 17 illustrates an exploded view of the example control panel 1602 of FIGS. 16A and 16B that includes an enlarged, exploded view 1700 of the internal components of the first deflection system 1624. As shown in FIG. 17, the example first deflection system 1624 includes a stack of example first shock absorbing bodies 1702, an example second shock absorbing body 1704 (e.g., an upper shock absorbing body), an example shaft 1706, and example third shock absorbing bodies 1708 (e.g., a lower shock absorbing body). The example first deflection system 1624 extends along an example axis 1710 (e.g., center axis, longitudinal axis, longitudinal direction, etc.). In some examples, a center axis of the casing 1630 is generally aligned relative to a center axis of the shaft 1706 and/or the axis 1710.

The example shaft 1706 includes an example flange (e.g., portion) 1712 that surrounds an example outer surface (e.g., outer side wall) 1714 of the shaft 1706. As shown in FIG. 17, the example flange 1712 is positioned on the outer surface 1714. The example flange 1712 extends (e.g., protrudes) away from the shaft 1706 in a radial direction from a center axis of the shaft 1706 and/or the axis 1710. However, the example flange 1712 may extend in any direction away from a center axis of the shaft 1706, the axis 1710, the outer surface 1714 of the shaft 1706, etc. In other words, the example flange 1712 may protrude from the shaft 1706 in a direction transverse to an elongate length of the shaft 1706. Additionally or alternatively, the example flange 1712 may include multiple separate portions. For example, a first portion of the flange 1712 can be spaced apart from a second portion of the flange 1712 in a direction extending circumferentially around the shaft 1706. In such examples, the first portion of the flange 1712 can extend in a first direction away from the outer surface 1714 and the second portion of the flange 1712 can extend in a second direction away from the outer surface 1714, the second direction different from the first direction.

In FIG. 17, the example second and third shock absorbing bodies 1704, 1708 may be coaxially aligned to each other and/or aligned to the axis 1710. As shown in FIG. 17, the third shock absorbing bodies 1708 are closer to the bottom of the first deflection system 1624 than the second shock absorbing body 1704. Accordingly, for purposes of explanation, the second and third shock absorbing bodies 1704, 1708 are referred to herein as upper and lower shock absorbing bodies respectively. The example upper and lower shock absorbing bodies 1704, 1708 may be annular rings (e.g., compressible rings) that extend circumferentially around the shaft 1706. In other examples, the upper shock absorbing body 1704 and/or the lower shock absorbing bodies 1708 may be defined by a plurality of circumferentially distinct bodies that have a generally spherical shape. That is, in some examples, rather than being one continuous ring (as shown), one or both of the upper and lower shock absorbing bodies 1704, 1708 may be implemented with multiple, discrete balls or spheres arranged to surround (e.g., at least partially surround) the shaft 1706, the outer surface 1714, the axis 1710, etc. In some such examples, the discrete circumferential portions of the upper and lower shock absorbing bodies 1704, 1708 may have a shape other than a sphere (e.g., cubes, cylinders, etc.).

Additionally or alternatively, the example upper and lower shock absorbing bodies 1704, 1708, can include any suitable cross sectional shape. Thus, as shown in the illustrated example, the upper shock absorbing body 1704is doughnut-shaped (e.g., a toroid with a circular and/or oval cross-section). In other examples, the cross-sectional shape can be different (e.g., a square or rectangular shape, trapezoidal, irregular, etc.). In some examples, both the upper and lower shock absorbing bodies 1704, 1708 have the same size, shape, and design. However, in other examples, the size, shape, and/or design of the upper and lower shock absorbing bodies 1704, 1708 can differ. For instance, unlike the upper shock absorbing body 1704, the two lower shock absorbing bodies 1708 have a toroid shape with a semi-circular (or semi-oval) cross-section. That is, the shock absorbing bodies 1708are bagel-shaped with flat surfaces 1716 facing towards one another and rounded surfaces 1718 facing away from one another. In this example, the combined shape of the two lower shock absorbing bodies 1708 is similar to the single upper shock absorbing body 1704. Although the sock absorbing bodies 1708 are shown and described as having a semi-circular (or semi-oval) cross-section, other shapes are possible. For instance, in some examples, the round portion of the semi-circular cross-section (e.g., the round surface 1718) is to define a relatively small flat annular surface opposite the larger flat surface 1716 shown in the illustrated example. In other examples, the shock absorbing bodies 1708 can have a rectangular cross-section. In some examples, more than two shock absorbing bodies 1708 can be positioned below the flange 1712. Similarly, in some examples, more than one upper shock absorbing body 1704 can be positioned above the flange 1712. In some examples, the single upper shock absorbing body 1704 can be replaced by two bagel-shaped bodies similar to the lower shock absorbing bodies 1708 shown in the illustrated example. In some examples, the two lower shock absorbing bodies 1708 can be replaced by a single doughnut-shaped body similar to the upper shock absorbing body 1704 shown in the illustrated example. Thus, in some examples, bagel-shaped shock absorbing bodies can be used both above and below the flange 1712 and/or doughnut-shaped shock absorbing bodies can be used both above and below the flange 1712. Further, in some examples, bagel-shaped shock absorbing bodies can be used on either side of (above or below) the flange 1712 while doughnut-shaped shock absorbing bodies are used on the other side. Generally speaking, any suitable number of one or more shock absorbing bodies having any suitable cross-sectional shape may be positioned above the flange 1712 in combination with any suitable number of one or more shock absorbing bodies having any suitable cross-sectional shape may be positioned below the flange 1712. In some examples, shock absorbing bodies 1704, 1708 can include multiple assembled or stacked elements (e.g., rings or doughnuts). These elements can be of the same or different shapes and made of the same or different materials.

FIG. 18A is a cross-sectional side view of the example control panel 1602 of FIG. 16A taken along a plane passing vertically through the first deflection system 1626. FIG. 18B illustrates an enlarged view of the first deflection system 1626 shown in FIG. 18A. As shown in the illustrated example, the shaft 1706 includes a first portion 1800 that extends in a first direction from the flange 1712 to a first end 1804 of the shaft and a second portion 1802 that extends in a second direction from the flange 1712 to a second end 1806 of the shaft, the second direction different from the first direction. In this example, the first and second portions 1800, 1802 extend in a direction generally aligned to the center axis 1710 of the shaft 1706. In some examples, the first and second portions 1800, 1802 can extend along direction(s) transverse (e.g., at an angle) to the center axis 1710.

The example flange 1712 is positioned between the first end 1804 of the shaft 1706 and the second end 1806 of the shaft 1706 opposite the first end 1804. In this example, the flange 1712 is spaced apart from both of the ends 1804, 1806 of the shaft 1706. Further, when the first deflection system 1626 is assembled, the example anchor 1628 is positioned at the first end 1804 of the shaft 1706 to enclose at least the flange 1712, the first portion 1800, and the first end 1804. In particular, the example mounting flange 1632 of the anchor 1628 is adjacent to the first end 1804 of the shaft 1706. That is, in this example, the first portion 1800 of the shaft 1706 is shorter than the second portion 1802 of the shaft 1706. The example anchor 1628 includes a cavity 1808 to receive the flange 1712 and the first end 1804.

The example flange 1712 includes a first surface (e.g., face) 1810 that faces towards the first end 1804 of the shaft 1706 and a second surface (e.g., face) 1812 that faces in the opposite direction (e.g., towards the second end 1806 of the shaft 1706). The example lower shock absorbing bodies 1708 are to be at least partially positioned between the first surface 1810 of the flange 1712 and the first end 1804. Further, the example lower shock absorbing bodies 1708 can be positioned closer to the first end 1804 than the flange 1712 is to the first end 1804 (e.g., adjacent the first portion 1800 of the shaft 1706). In some examples, the uppermost lower shock absorbing body 1708 is to be in contact with the first surface 1810 of the flange 1712. Further, in some examples, the lower shock absorbing bodies 1708 are to be in contact with the first portion 1800 of the shaft 1706. Additionally or alternatively, the lower shock absorbing bodies 1708 are to be positioned within the cavity 1808 adjacent (e.g., directly adjacent) the outer surface 1714 of the shaft 1706. As such, the example lower shock absorbing bodies 1708 can be arranged to at least partially surround (e.g., encircle) the outer surface 1714, the first portion 1800 of the shaft 1706, the first end 1804, etc.

In some examples, the lower shock absorbing bodies 1708 are to be positioned between the first surface 1810 and a base plate 1811 (e.g., a mounting plate, a support plate) of the brace 1610 to which the anchor 1628 is connected. In some examples, an entirety of the example lower shock absorbing bodies 1708 are to be closer to the brace 1610 than the flange 1712 is to the brace 1610. As such, the example lower shock absorbing bodies 1708 can separate the flange 1712 from the brace 1610. In other words, the example flange 1712 does not engage with the brace 1610 when the deflection system 1624 is mounted to the brace 1610 (e.g., the base plate 1811). Further, in some examples, the lower shock absorbing bodies 1708 have a combined thickness that is greater than a length of the first portion 1800 of the shaft 1706. As such, as most clearly shown in FIG. 18B, at least the lowermost lower shock absorbing body 1708 extends beyond the first end 1804 of the shaft 1706 when the uppermost lower shock absorbing body 1708 is in contact with first surface 1810 of the flange 1712.

In this example, example outer surfaces of the shock absorbing bodies 1704, 1708 contact an example side wall (e.g., inner wall, side surface, vertical side wall, inner surface, etc.) 1814 of the anchor 1628. The example upper shock absorbing body 1704 is positioned between the second surface 1812 of the flange 1712 and the side wall 1814 of the anchor 1628. Additionally, the example upper shock absorbing body 1704 contacts an inside upper surface 1815 of the anchor 1628 and the second surface 1812 of the flange 1712. As such, the upper shock absorbing body 1704 separates the second surface 1812 of the flange 1712 from the upper surface 1815 of the anchor 1628. Further, the example upper shock absorbing body 1704 can be positioned adjacent the outer surface 1714 of the shaft 1706 (e.g., along the second portion 1802 of the shaft 1706). The example flange 1712 can be positioned between (e.g., separate) the upper shock absorbing body 1704 and the lower shock absorbing bodies 1708. Accordingly, in this example, the upper shock absorbing body 1704 is entirely above (e.g., higher than, entirely separate from, etc.) the lower shock absorbing bodies 1708. For example, a lowermost portion of the upper shock absorbing body 1704 is entirely above an uppermost portion of the lower shock absorbing bodies 1708.

The example anchor 1628 encloses the first portion 1800 of the shaft 1706, the flange 1712, the upper shock absorbing body 1704, and the lower shock absorbing bodies 1708. Additionally, the example anchor 1628 includes an opening 1816 to enable the second portion 1802 of the shaft, including the second end 1806, to protrude (e.g., extend) from the anchor 1628. For example, the second portion 1802 of the shaft 1706 extends away from the anchor 1628 along a longitudinal direction (e.g., the center axis 1710) of the shaft 1706. In some examples, the shaft 1706 can extend any suitable distance above the anchor 1628 (e.g., halfway up the height of the casing 1630, less than halfway up the height of the casing 1630, more than halfway the height of the casing 1630, etc.).

In this example, a diameter (e.g., size) of the flange 1712 is greater than a diameter of the opening 1816. Accordingly, the size of the flange 1712 prevents the flange 1712 from fitting through the opening 1816 during assembly and/or operation. The example upper shock absorbing body 1704 may be positioned on the upper surface 1812 of the flange 1712 prior to positioning (e.g., feeding) the shaft 1706 through the opening 1816. As such, the example upper shock absorbing body 1704 can be sandwiched between the upper surface 1815 and the flange 1712. Then, the example lower shock absorbing bodies 1708 can be added to the example assembly. However, the example lower shock absorbing bodies 1708 may be added to the assembly at any time prior to securing the deflection system 1624 to the brace 1610 (e.g., the base plate 1811).

The example casing 1630 at least partially encloses (e.g., encloses, fully encloses, covers, etc.) the second portion 1802 of the shaft 1706. The outer surface 1714 of the shaft 1706 can be spaced apart from an example inner surface 1818 of the casing 1630 to define an example chamber 1820 therebetween when the casing 1630 surrounds the shaft 1706.

Further, the example deflection system 1624 includes at least one of the first shock absorbing bodies 1702 that separates (e.g., is positioned between) the second portion 1802 of the shaft 1706 and the inner surface 1818 of the casing 1630. For example, the first shock absorbing bodies 1702 can fill at least a portion of the chamber 1820 between the shaft 1706 and the casing 1630. In this example, the first shock absorbing bodies 1702 are positioned to surround a perimeter (e.g., the outer surface 1714) of the shaft 1706. More particularly, in this example, each of the first shock absorbing bodies 1702 includes a hole 1722 through which the shaft 1706 extends. In some examples, the diameter of the hole 1722 is equal to or slightly smaller than the diameter of the shaft 1706 to provide a tight fit (e.g., a press-fit) around the shaft 1706. In other examples, the diameter of the hole 1722 can be larger than the shaft 1706.

In the illustrated example, each of the first shock absorbing bodies 1702 extends continuously around a circumference of the shaft 1706. In other examples, the first shock absorbing bodies 17 do not extend continuously all the way the shaft 1706. For instance, in some examples, multiple discrete shock absorbing bodies can be positioned at different circumferential positions around the shaft at a given height within the casing. More particularly, in some examples, rather than a single body with a hole 1722 through the middle, each first shock absorbing body 1722 can be implemented by two discrete C-shaped bodies that collectively encircle the shaft 1706. In other examples, more than two shock absorbing bodies may be employed to surround the shaft. In some examples, the discrete bodies can have any suitable shape (e.g., spheres, cylinders, cubes, polygonal prisms, etc.) and do not necessarily need to combine to define the same overall shape as the first shock absorbing bodies 1702 shown in FIG. 17.

In some examples, the first shock absorbing bodies 1702 are stacked on top of one another within the chamber 1820. In this example, the lowermost one of the first shock absorbing bodies 1702 is in contact with (e.g., rests upon) an exterior surface (e.g., outer surface) 1824 of the anchor 1628 to the second end 1806 of the shaft 1706. In this example, the exterior surface 1824 is adjacent to the opening 1816. In some examples, the stack of first shock absorbing bodies 1702 can extend from the anchor 1628 (e.g., stack on top of one another) to fill a majority of the casing 1630. More particularly, in some examples, as shown in FIG. 18B, the uppermost first shock absorbing body 1702 is relatively close to but spaced apart from an inside upper surface 1826 of the casing 1630. In other examples, the stack of first shock absorbing bodies 1702 extend from the anchor 1628 (e.g., stack on top of one another) to completely fill the casing 1630 (e.g., the uppermost first shock absorbing body 1702 is in contact with the upper surface 1826 of the casing 1630). In some such examples, the total thickness of the stack of first shock absorbing bodies 1702 is slightly greater than the inside height of the casing 1630 such that the first shock absorbing bodies 1702 are placed in vertical compression along the axial length of the casing 1630 due to the weight of the control panel 1602. In some examples, the first shock absorbing bodies 1702 can be stacked to any suitable height above the anchor 1628 (e.g., halfway up the height of the casing 1630, less than halfway up the height of the casing 1630, more than halfway the height of the casing 1630, etc.).

In the illustrated example, the stack of first shock absorbing bodies 1702 extend beyond the second end 1806 of the shaft 1706. That is, the total axial height of the stack of the first shock absorbing bodies 1702 is sufficient to extend along the entire length of the second portion 1802 of the shaft 1706 exposed through the anchor 1628. More particularly, in this example, the stack of first shock absorbing bodies 1702 extends slightly beyond the top (e.g., second end 1806) of the shaft 1706. In other examples, the stack of first shock absorbing bodies 1702 can extend farther beyond the second end 1806 of the shaft 1706 than what is shown in FIG. 18B. In some examples, the length of the shaft 1706 relative to the total axial height of the stack of the first shock absorbing bodies 1702 results in at least one of the shock absorbing bodies 1702 being completely above the second end 1806 of the shaft 1706. That is, in some examples, the stack of first shock absorbing bodies 1702 extends beyond the second end 1806 of the shaft 1706 by more than the axial thickness 1724 of ones of the first shock absorbing bodies 1702. In other examples, the first shock absorbing bodies 1702 may not extend beyond the second end 1806 of the shaft 1706. In some examples, the second end 1806 of the shaft 1706 extends beyond the elongate shock absorbing bodies 1702. In some examples, the length of the shaft 1706 is dimensioned so that the second end 1806 interfaces with (e.g., contacts) the inside upper surface 1826 of the casing 1630.

In this example, the first shock absorbing bodies 1702 have a generally rectangular shape that corresponds to the rectangular cross-sectional shape of the casing 1630 so as to fill or substantially fill the cross-sectional area of the casing 1630 that surrounds the shaft 1706. In this example, the longer dimension of the generally rectangular shape of the first hock absorbing bodies 1702 is oriented to be transverse (e.g., substantially perpendicular) to a line extending between the posts 1604, 1606 . . . . In other examples, the first shock absorbing bodies 1702 may have any other suitable shape or cross-section. In some examples, the first shock absorbing bodies 1702 are slightly larger than the internal dimensions of the casing 1630 so that the first shock absorbing bodies 1702 are slightly compressed (e.g., press-fit) inside the casing 1630. In other examples, the first shock absorbing bodies 1702 are slightly smaller than the casing 1630 to provide clearance between the bodies 1702 and the internal walls of the casing 1630.

In this example, the stack of first shock absorbing bodies 1702 includes fourteen individual shock absorbing bodies. However, in other examples, any other number of first shock absorbing bodies 1702 may be employed. The particular number used depends on the total axial distance (e.g., height) of the stack of first shock absorbing bodies 702 and the size (e.g., axial thickness 1724) of each one of the first shock absorbing bodies 1702. In some examples, different ones of the first shock absorbing bodies 1702 can have different axial thicknesses 1724. As shown most clearly in the illustrated example FIG. 17, the axial thickness 1724 is less than a width 1726 of the first shock absorbing bodies 1702, which is less than a length 1728 of the first shock absorbing bodies 1702. In this example, the width 1726 is less than twice the size (e.g., diameter) of the hole 1722 and the length 1728 is greater than twice the size of the hole 1722. In other examples, the width 1726 can be equal to or greater than twice the size of the hole and/or the length 1728 can be equal to or less than twice the size of the hole 1722. In some examples, the axial thickness 1724 is equal to or greater than the width 1726 and/or the axial thickness 1724 is equal to or greater than the length 1728. In some such examples, the axial thickness 1724 can be many times greater than the width 1726 and/or the length 1728. That is, in some examples, multiple ones of the first shock absorbing bodies 1702 are integrally formed to define a sleeve or tube that extends continuously along a length of the shaft 1706. In some examples, a single shock absorbing body 1702 with a tubular shape can be used with an axial thickness 1706 (e.g., a tubular length) corresponding to the total axial distance of the stack of annular shock absorbing bodies 1702 shown in FIG. 7. That is, in some examples, the deflection system 1624 includes only one first shock absorbing body 1702. However, in some examples, implementing multiple smaller first shock absorbing bodies 1702 can facilitate the assembly of the deflection system 1624. In this example, each of the annular shock absorbing bodies 1702 are the same size. However, in other examples, different ones of the annular shock absorbing bodies 1702 can be different sizes.

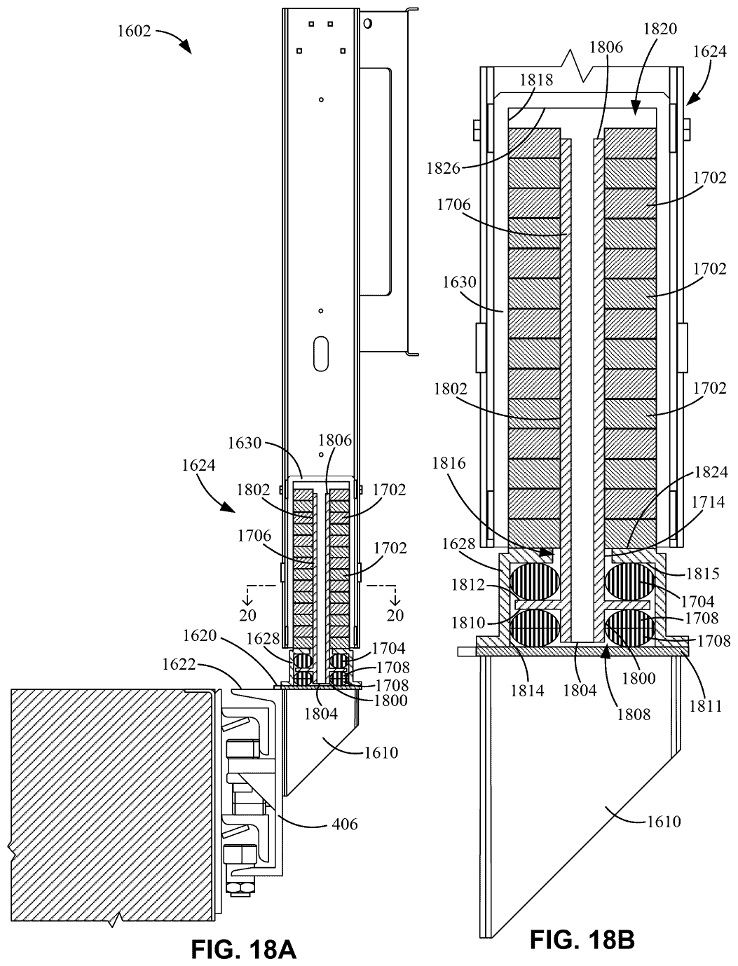

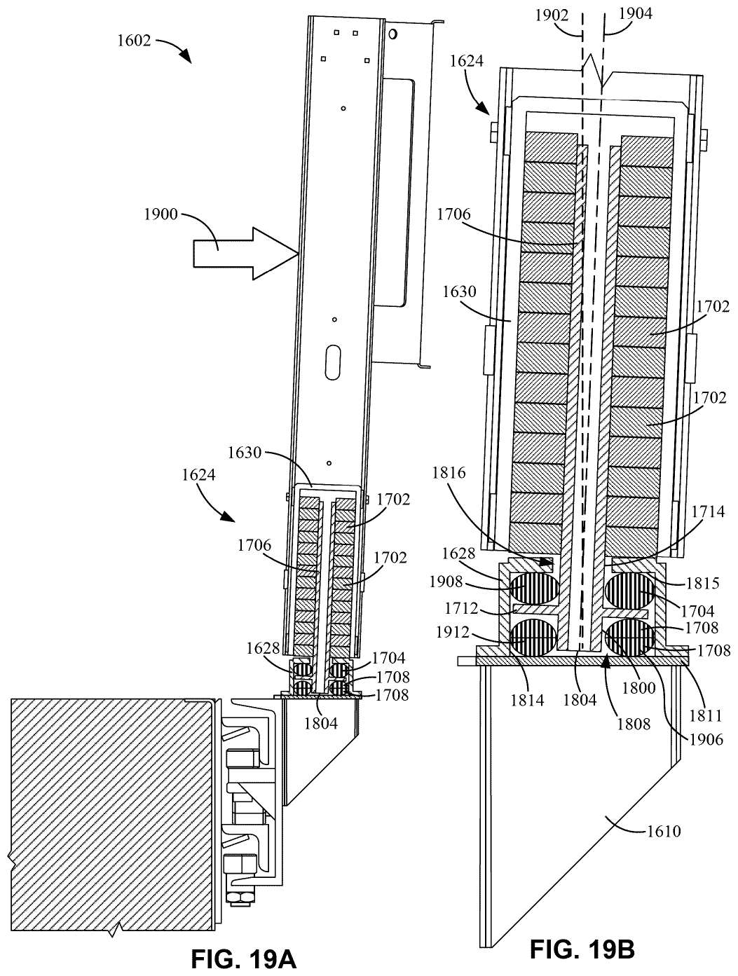

FIG. 19A illustrates a cross-sectional side view of the example control panel 1602 similar to what is shown FIG. 18A but showing the control panel 1602 during an impact. FIG. 19B illustrates an enlarged view of the first deflection system 1626 shown in FIG. 19A. In this example, the control panel 1602 is shown to be under impact, force, load, etc., along a direction as generally shown by an example force vector 1900. The example the force impacting the control panel 1602 causes a displacement of the example control panel 1602. For example, prior to impact the example control panel 1602 may have been generally aligned to a first example axis (e.g., upright axis) 1902. After impact and/or during impact, the example control panel 1602 is moved (e.g., leaned, titled, angled, shifted, etc.) to a second example axis (e.g., displaced axis) 1904. In the example of FIGS. 19A and 19B, during an impact the components of the deflection system 1624 (e.g., example first, second, and third shock absorbing bodies 1702, 1704, 1708, the shaft 1706, and the casing 1630) may be moved to different positions and/or angles relative to each other and/or relative to their position before the impact shown in FIGS. 18A and 18B.

The design and construction of the example deflection system 1624 provide several mechanisms to absorb impacts of various severities represented by the force vector 1900. The first shock absorbing bodies 1702 serve as the initial point of contact with an impact and, therefore, the initial shock absorbing mechanism of the deflection system 1624. That is, for relatively small impact forces, the first shock absorbing bodies 1702 may be able to deform (e.g., compress) to absorb the impact without significantly affecting the rest of the assembly. The example first shock absorbing bodies 1702 may be made of compressible materials (e.g., natural rubber, polyurethane, polyethylene foam, closed cell foams, etc.) to enable such compression, deformation, resiliency, etc. In some examples, an outer surface of a first one of the first shock absorbing bodies 1702 may engage with (be urged against) an outer surface of a second one of the first shock absorbing bodies 1702 during an impact with the control panel 1602. In such examples, the second one of the first shock absorbing bodies 1702 supports and/or cushions movement of the first one of the first shock absorbing bodies 1702. Further, the first shock absorbing bodies 1702 are positioned to cushion the shaft 1706 from contacting the casing 1630. In some examples, the first shock absorbing bodies 1702 engage with (e.g., contact) the outer surface 1714 of the shaft 1706 to resist and/or dampen movement of the shaft 1706.

In some examples, the first shock absorbing bodies 1702 may include materials that have a relatively high coefficient of friction such that adjacent ones of the first shock absorbing bodies 1702 can grip (e.g., attach, adhere, stick, etc.) to one another and/or the casing 1630. For example, an outer surface of at least one of the first shock absorbing bodies 1702 can adhere to the inner surface 1818 of the casing 1630. The example outer surface of the at least one of the first shock absorbing bodies 1702 resists movement of the casing 1630 based on the friction between the outer surface of the at least one of the first shock absorbing bodies 1702 and the inner surface 1818. That is, during an impact the example casing 1630 not only moves sideways but may also be urged upward (e.g., away from the anchor 1628.) However, the relatively high friction surfaces of the first shock absorbing bodies 1702 can reduce (e.g., eliminate) vertical movement of the casing 1630.

In other examples, an outer surface of a first one of the first shock absorbing bodies 1702 can adhere to an outer surface of a second one of the first shock absorbing bodies 1702. The example outer surface of the second one of the first shock absorbing bodies 1702 resists vertical movement of the first one of the first shock absorbing bodies 1702 based on the friction between the outer surfaces of the first and second first shock absorbing bodies 1702. As such, the first shock absorbing bodies 1702 may engage with one another to distribute (e.g., counteract) force experienced by the shaft 1706 and/or the control panel 1602.

If the impact force is great enough, the force may be transferred through the first shock absorbing bodies 1702 to the shaft 1706. Such a force can cause the shaft 1706 to shift or tilt as shown in the illustrated example. In this example, a size (e.g., diameter, width, etc.) of the flange 1712 is less than a size (e.g., diameter, width, etc.) of the cavity 1808. As such, there may be a gap and/or clearance between the flange 1712 and the side wall 1814 to permit the shaft 1706 to tilt. In some examples, the flange 1712 may contact the side wall 1814 of the anchor 1628 such that the anchor 1628 absorbs at least some of the impact force. However, as shown in FIG. 19B, the tilting of the shaft 1706 can result in the shaft 1706 and/or the flange 1712 (tilting with the shaft 1706) being pressed or urged against the second and third shock absorbing bodies 1704, 1708 within the anchor 1628. In this example, the shaft 1706 may be made of a material that is harder (e.g., more stiff, less compressible or deformable, etc.) than the first shock absorbing bodies 1702. For example, the shaft 1706 may be a steel shaft that can tilt in response to force.

Similar to the example first shock absorbing bodies 1702, the second and third shock absorbing bodies 1704, 1708 may be made from a compressible material (e.g., natural rubber, polyurethane, polyethylene foam, closed cell foams, etc.) that can deform under force. In some examples, the upper and lower shock absorbing bodies 1704, 1708 are made of the same material as the first shock absorbing bodies 1702. In other examples, the upper and lower shock absorbing bodies 1704, 1708 are made of a different material from the first shock absorbing bodies 1702. That is, in some examples, the upper and lower shock absorbing bodies 1704, 1708 are stiffer than the first shock absorbing bodies 1702. In other examples, the first shock absorbing bodies 1702 are stiffer than the upper and lower shock absorbing bodies 1704, 1708. In some examples, the upper shock absorbing body 1704 is made of a different material (e.g., has a different stiffness) from the lower shock absorbing bodies 1708. Generally speaking, the example shock absorbing bodies 1704, 1708 are resiliently compressible or deformable but firm to support (e.g., hold, stabilize) the shaft 1706 prior to and/or during impact. For example, at least the lower shock absorbing bodies 1708 can compress when the deflection system 1624 is assembled such that the lower shock absorbing bodies 1708 support the weight of shaft 1706. The example lower shock absorbing bodies 1708 may extend beyond the first end 1804 of the shaft 1706 prior to assembly. Then, when the shaft 1706 and the lower shock absorbing bodies 1708 are assembled within the anchor 1628, and the anchor 1628 is secured to the base plate 1811 of the brace 1610, the lower shock absorbing bodies 1708 are compressed (e.g., squeezed) between the flange 1712 and the base plate 1811. The example lower shock absorbing bodies 1708 can maintain clearance (e.g., space, gap, etc.) between the first end 1804 and the base plate 1811 of the brace 1610. Additionally or alternatively, the example lower shock absorbing bodies 1708 can maintain clearance between the flange 1712 and the base plate 1811 prior to and/or during operation. Further, the example upper shock absorbing body 1704 may be compressed when the anchor 1628 is secured to the base plate 1811. As such, the example upper shock absorbing body 1704 may be compressed between the anchor 1628 and the flange 1712.

The upper and lower (e.g., second and third) shock absorbing bodies 1704, 1708 are positioned to counteract (e.g., cushion, absorb, etc.) an impact on the control panel 1602. That is, as shown most clearly in FIG. 19B, an example first portion 1906 of the lower shock absorbing bodies 1708 resists a generally downward motion (e.g., force) of the flange 1712 as the shaft 1706 tips. Accordingly, the example first portion 1906 of the lower shock absorbing bodies 1708 can prevent the flange 1712 from contacting the base plate 1811 of the brace 1610 during operation. Further, an example first portion 1908 of the upper shock absorbing body 1704 resists a generally upward motion of the flange 1712 as the shaft 1706 tips. Accordingly, the example first portion 1908 of the upper shock absorbing body 1704 can prevent the flange 1712 from contacting the upper surface 1815 of the anchor 1628 and/or the side wall 1814. In some examples, an example second portion 1912 of the lower shock absorbing bodies 1708 resists a generally lateral and/or rotational motion of the first portion 1800 of the shaft 1706. For example, the second portion 1912 of the lower shock absorbing bodies 1708 can prevent the first portion 1800 from contacting the side wall 1814 of the anchor 1628.

As shown in FIGS. 19A and 19B, a diameter of the shaft 1706 is less than a diameter of the opening 1816. For relatively small impacts, the clearance between the shaft 1706 and the opening 1816 permits the shaft 1706 to tilt without necessarily contacting the anchor 1628. However, for relatively large impacts, the forces involved may overcome the reactionary forces from both the first shock absorbing bodies 1702 and the second and third shock absorbing bodies 1704, 1708 within the anchor 1628 as described above. In such situations, the shaft 1706 will be urged even further than shown in FIGS. 19A and 19B until the outer surface 1714 of the shaft 1706 comes into contact with the rim of the opening 1816 in the anchor 1628. As a result, the force of impact will transfer directly from the rigid shaft 1706 to the rigid anchor 1628. However, in many instances, a significant portion of the impact will have already been absorbed by the first shock absorbing bodies 1702 and the second and third shock absorbing bodies 1704, 1708, thereby reducing the likelihood of any significant damage to the control panel 1602 (or the object impacting the control panel 1602).

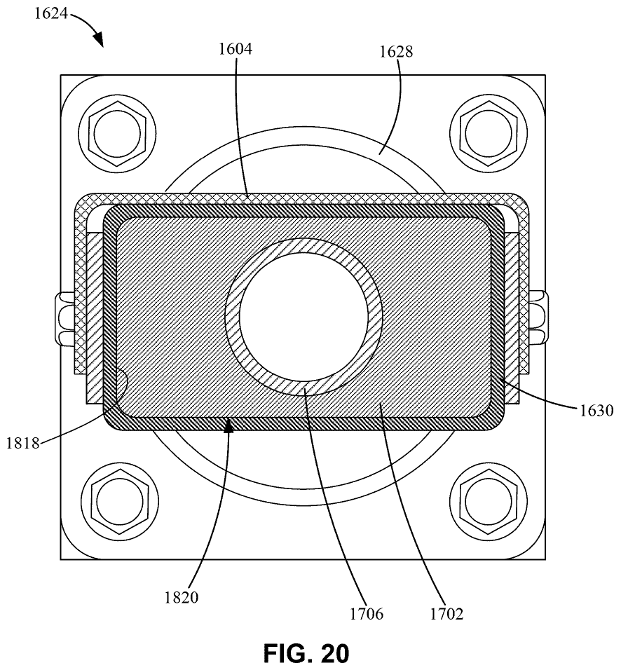

FIG. 20 is a cross-sectional top view of the example first deflection system 1624 taken along line 20-20 of FIG. 18A. As shown in FIG. 20, the example first shock absorbing bodies 1702 are positioned to surround the shaft 1706. The example casing 1630 encircles the first shock absorbing bodies 1702. In this example, the example chamber 1820 surrounding the shaft is substantially filled (e.g., packed, fully filled, completely filled) by the first shock absorbing bodies 1702. In other examples, the first shock absorbing bodies 1702 are shaped and/or dimensioned to define some open regions within the chamber 1820 between the inner surface 1818 of the casing 1630 and the shaft 1706.

The foregoing examples of railcar ramp system 102, the control panel 136, the control panel 1002, the control panel 1102, the control panel 1500, the control panel 1602, and/or other components disclosed herein can be employed with railcar loading system, a loading dock, a warehouse, and/or any other transport or storage system. Although each example of the railcar ramp system 102, the control panel 136, the control panel 1002, the control panel 1102, the control panel 1500, and/or the control panel 1602, disclosed above have certain features and/or components, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features. In some examples, a dock leveler, a railcar loading bay, a warehouse, an interior of a warehouse, an exterior of a warehouse, etc. in accordance with the teachings of this disclosure may have a combination of the features of the example disclosed herein.

For instance, in some examples, the pivot hinge 1112 of FIG. 11A can be implemented with the carriage 406 of FIG. 4. In some examples, the deflection systems 1624, 1626 detailed in FIGS. 16A-20 can be incorporated into any of the example control panels 136, 1002, 1102, 1500 of FIGS. 1-15D. For instance, in some examples, the deflection systems 1624, 1626 can be incorporated into control panels that also include a pivot hinge (e.g., the pivot hinges 600, 1112, 1504 disclosed above) for additional modes of deflection in response to an impact. That is, in some examples, rather than the braces 1610, 1612 being attached directly to the side of the carriage 406, the braces 1610, 1612 may be pivotally coupled to the carriage 406 via hinges as discussed above.

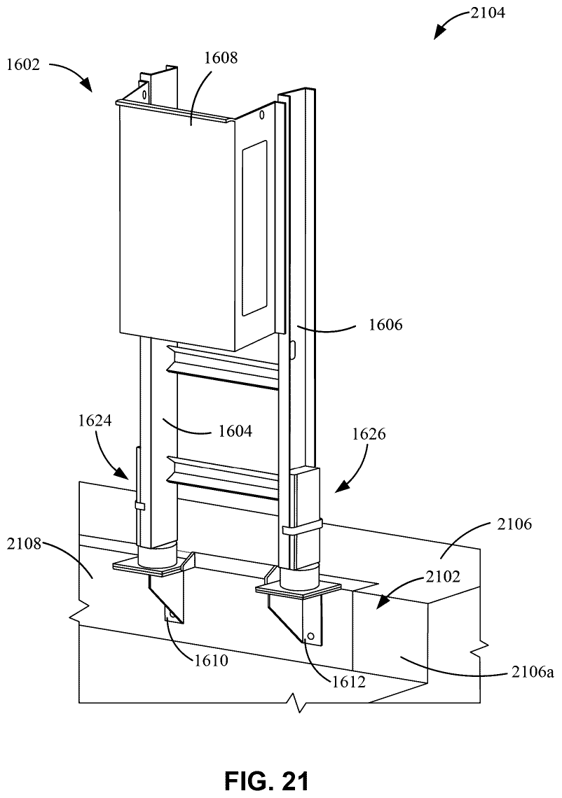

In some examples, the control panel 1602 of FIGS. 16A-20 can be attached to other surfaces other than the carriage 406. For instance, in some examples, the control panel 1602 can be implemented independent of the example railcar ramp system 100. Specifically, FIG. 21 is a perspective view of the example control panel 1602 of FIGS. 17-20 at the edge of a pit 2102 at an example loading dock 2104. Many of the components of the example loading dock 2104 and/or control panel 1602 are substantially similar or identical to the components described above in connection with FIGS. 16A-20. As such, those components will not be described in detail again below. Instead, the interested reader is referred to the above corresponding descriptions for a complete written description of the structure and operation of such components. To facilitate this process, similar or identical reference numbers will be used for like structures in FIG. 21 as used in FIGS. 16A-20. In the illustrated example of FIG. 21, the control panel 1602 is coupled to (e.g., directly coupled or mounted to) a platform 2106 (i.e., instead of a carriage (e.g., the carriage 406)). The control panel 1602 of the illustrated example is attached to the platform 1206 (e.g., a vertical wall 2106a) via a mounting plate 2108 (e.g., a fixed mounting plate). The mounting plate 2108 fixes a lateral position of the control panel 1602 relative to the pit 2102 of the loading dock 2104. Thus, the control panel 1602 of FIG. 21 cannot move along the platform 2106. However, the control panel 1660 is still able to deflect, tilt, or otherwise move relative to the platform 2106 via the deflection systems 1624, 1626. In some examples, the control panel 1602 is positioned on the platform 2106 adjacent to a dock leveler. However, the control panel 1602 can be positioned any location along the mounting plate 2108 regardless of the location of other surrounding structures.

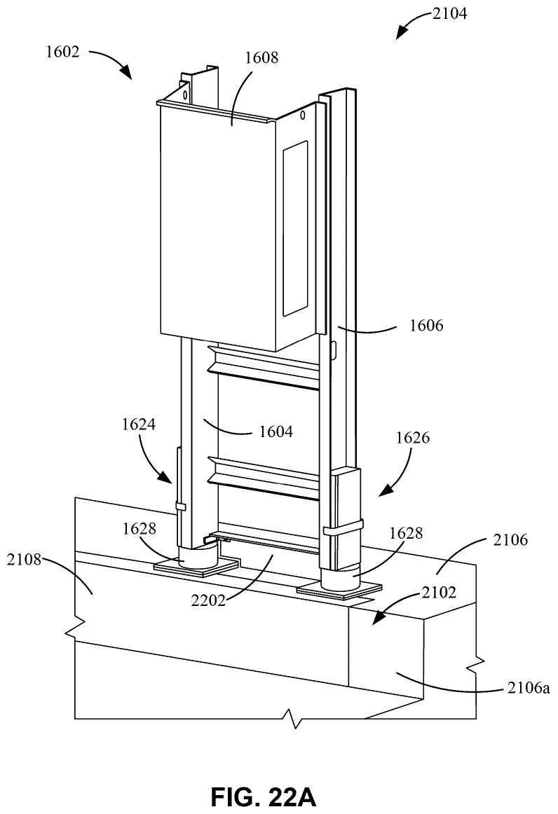

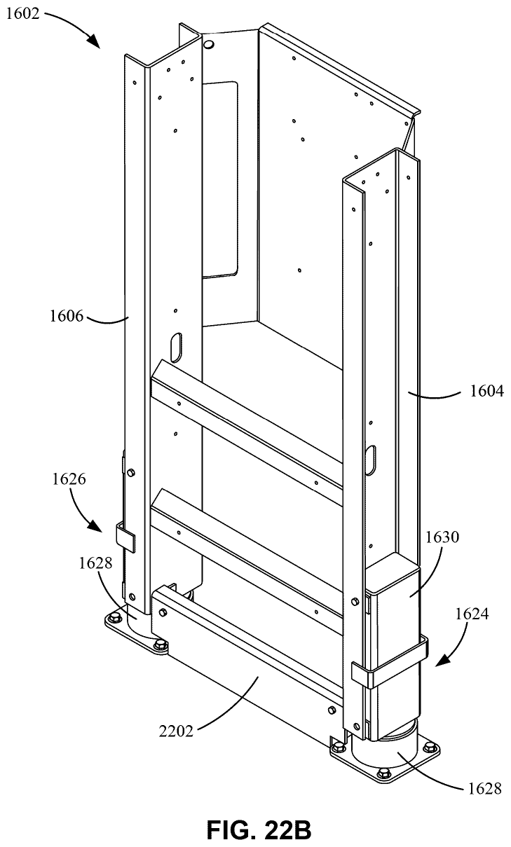

FIG. 22A is a rear perspective view of the example control panel 1602 of FIG. 21 that has been modified in accordance with teaching disclosed herein to be mounted to a top surface of the platform 1206 rather than the vertical wall 1206a as shown in FIG. 21. FIG. 22B is a front perspective view of the control panel 1602 of FIG. 22A with the surrounding structure removed for the sake of clarity. In the arrangement shown in FIG. 22A, the braces 1610, 1612 (used in FIG. 21) are omitted. Instead, the anchors 1628 of the deflection systems 1624, 1626 are mounted directly into the walking surface of the platform 1206. In some examples, the anchors 1628 are mounted (e.g., using threaded fasteners) into the top surface of the mounting plate 2108. Additionally or alternatively, the anchors 1628 can be mounted into the platform 2106 at a location spaced apart from the mounting plate 2108. More generally, the example control panel 1602 can be mounted at any location where there is a flat (e.g., horizontal) surface (e.g., ground) using the anchors 1628 without the use of the braces 1610, 1612. In some examples, when the anchors 1628 are directly mounted onto a flat surface, a different crossbeam 2202 is used than the crossbeam 1618 that is used in combination with braces 1610, 1612.

From the foregoing, it will be appreciated that example systems, apparatus, articles of manufacture, and methods have been disclosed that utilize shock absorbing material to resist impacts experienced by example control panel masts. Examples disclosed herein reduce the risk of damage to control panels by employing shock absorbing material that can contact a shaft and/or an anchor of a deflection system incorporated into the control panel. Examples disclosed herein utilize a shaft flange to distribute forces to other load bearing portions of the control panel.

At least some of the aforementioned examples include one or more features and/or benefits including, but not limited to, the following:

Example 1 includes a control panel comprising a post to support a control box for the control panel, and a deflection system including an anchor to support the post, the anchor couplable to a platform, a shaft to extend upward from the anchor along a length of the post, and a shock absorbing body adjacent the shaft, the shock absorbing body to absorb at least some of an impact with the control panel.

Example 2 includes the control panel of example 1, further including a brace, the anchor couplable to a vertical wall of the platform via the brace.

Example 3 includes the control panel of example 2, wherein the post is a first post, the control panel further including a second post spaced apart from the first post, and a crossbeam extending between the first and second posts, the crossbeam including a lip to engage with a top surface of the platform.

Example 4 includes the control panel of any one of examples 1-3, wherein the anchor includes a mounting flange, the anchor to be directly coupled to a walking surface of the platform via the flange.

Example 5 includes the control panel of any one of examples 1-4, wherein the anchor includes a cavity, a first portion of the shaft to be in the cavity, a second portion of the shaft to be external to the cavity, the shaft to extend through an opening in a wall of the anchor.

Example 6 includes the control panel of example 5, wherein the shaft includes a flange that extends radially away from a longitudinal axis of the shaft, the flange to be contained within the cavity.

Example 7 includes the control panel of any one of examples 5 or 6, wherein the shock absorbing body is disposed within the cavity, the shock absorbing body to circumferentially surround the shaft.

Example 8 includes the control panel of example 7, wherein the shock absorbing body is disposed between the flange and the wall of the anchor containing the opening.

Example 9 includes the control panel of example 7, wherein the flange is disposed between the shock absorbing body and the wall of the anchor containing the opening.

Example 10 includes the control panel of any one of examples 5 or 6, wherein the shock absorbing body is disposed outside of the cavity, the shock absorbing body to circumferentially surround the shaft.

Example 11 includes the control panel of example 10, wherein the shock absorbing body is one of a stack of shock absorbing bodies that are to surround the shaft.

Example 12 includes the control panel of any one of examples 10 or 11, further including a casing to surround the shock absorbing body.

Example 13 includes the control panel of example 12, wherein the post defines an internal channel, and the casing is to be positioned within the channel.

Example 14 includes the control panel of any one of examples 10-13, wherein the shock absorbing body defines a hole extending through a thickness of the shock absorbing body, the shaft to extend through the hole.

Example 15 includes the control panel of example 14, wherein the shock absorbing body has a width and a length, the thickness is less than the width, and the width is less than the length.

Example 16 includes a control panel comprising an anchor to couple the control panel to a platform, a post to extend upward from the anchor, a casing to be coupled to the post above the anchor, a shock absorbing body to be disposed within the casing above the anchor, and a shaft to extend from an inside of the anchor to an inside of the casing, the shock absorbing body to separate the shaft from an inner surface of the casing.

Example 17 includes the control panel of example 16, wherein the post is to rest on the anchor without being directly coupled to the anchor to enable the post to tilt relative to the anchor.

Example 18 includes the control panel of any one of examples 16 or 17, wherein the casing has a generally rectangular cross-sectional shape, and the shock absorbing body includes a shape corresponding to the cross-sectional shape of the casing.

Example 19 includes the control panel of any one of examples 16-18, further including a brace to facilitate coupling of the anchor to a vertical wall of the platform.

Example 20 includes a control panel comprising a mast to support electronic components for the control panel, a housing for shock absorbing bodies, the housing to be rigidly affixed to the mast, an anchor to facilitate coupling of the mast to a platform, and a shaft to extend through an opening in the anchor and through holes in the shock absorbing bodies, the shaft able to tilt relative the anchor while extending through the opening.

The following claims are hereby incorporated into this Detailed Description by this reference. Although certain examples, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. A control panel comprising:
a post to support a control box for the control panel; and
a deflection system including:
an anchor to support the post, the anchor couplable to a platform;
a shaft to extend upward from the anchor along a length of the post; and
a shock absorbing body adjacent the shaft, the shock absorbing body to absorb at least some of an impact with the control panel.

2. The control panel of claim 1, further including a brace, the anchor couplable to a vertical wall of the platform via the brace.

3. The control panel of claim 2, wherein the post is a first post, the control panel further including:
a second post spaced apart from the first post; and
a crossbeam extending between the first and second posts, the crossbeam including a lip to engage with a top surface of the platform.

4. The control panel of claim 1, wherein the anchor includes a mounting flange, the anchor to be directly coupled to a walking surface of the platform via the flange.

5. The control panel of claim 1, wherein the anchor includes a cavity, a first portion of the shaft to be in the cavity, a second portion of the shaft to be external to the cavity, the shaft to extend through an opening in a wall of the anchor.

6. The control panel of claim 5, wherein the shaft includes a flange that extends radially away from a longitudinal axis of the shaft, the flange to be contained within the cavity.

7. The control panel of claim 5, wherein the shock absorbing body is disposed within the cavity, the shock absorbing body to circumferentially surround the shaft.

8. The control panel of claim 7, wherein the shock absorbing body is disposed between the flange and the wall of the anchor containing the opening.

9. The control panel of claim 7, wherein the flange is disposed between the shock absorbing body and the wall of the anchor containing the opening.

10. The control panel of claim 5, wherein the shock absorbing body is disposed outside of the cavity, the shock absorbing body to circumferentially surround the shaft.

11. The control panel of claim 10, wherein the shock absorbing body is one of a stack of shock absorbing bodies that are to surround the shaft.

12. The control panel of claim 10, further including a casing to surround the shock absorbing body.

13. The control panel of claim 12, wherein the post defines an internal channel, and the casing is to be positioned within the channel.

14. The control panel of claim 10, wherein the shock absorbing body defines a hole extending through a thickness of the shock absorbing body, the shaft to extend through the hole.

15. The control panel of claim 14, wherein the shock absorbing body has a width and a length, the thickness is less than the width, and the width is less than the length.

16. A control panel comprising:
an anchor to couple the control panel to a platform;
a post to extend upward from the anchor;
a casing to be coupled to the post above the anchor;
a shock absorbing body to be disposed within the casing above the anchor; and
a shaft to extend from an inside of the anchor to an inside of the casing, the shock absorbing body to separate the shaft from an inner surface of the casing.

17. The control panel of claim 16, wherein the post is to rest on the anchor without being directly coupled to the anchor to enable the post to tilt relative to the anchor.

18. The control panel of claim 16, wherein the casing has a generally rectangular cross-sectional shape, and the shock absorbing body includes a shape corresponding to the cross-sectional shape of the casing.

19. The control panel of claim 16, further including a brace to facilitate coupling of the anchor to a vertical wall of the platform.

20. A control panel comprising:
a mast to support electronic components for the control panel;
a housing for shock absorbing bodies, the housing to be rigidly affixed to the mast;
an anchor to facilitate coupling of the mast to a platform; and
a shaft to extend through an opening in the anchor and through holes in the shock absorbing bodies, the shaft able to tilt relative the anchor while extending through the opening.
